(19) United States
(12) Patent Application Publication
(10) Pub. No.: US 2015/0046496 A1
(43) Pub. Date: Feb. 12, 2015

(54) METHOD AND SYSTEM OF GENERATING AN IMPLICIT SOCIAL GRAPH FROM BIORESPONSE DATA

(71) Applicants: Amit V. Karmarkar, Palo Alto, CA (US); Richard R. Peters, Mill Valley, CA (US)

(72) Inventors: Amit V. Karmarkar, Palo Alto, CA (US); Richard R. Peters, Mill Valley, CA (US)

(21) Appl. No.: 13/964,016

(22) Filed: Aug. 9, 2013

(51) Int. Cl. G06F 17/30; G06F 3/01

(52) U.S. Cl. CPC G06F 17/30958; G06F 3/013
USPC 707/798

(57) ABSTRACT

In one exemplary embodiment, a computer-implemented method of generating an implicit social graph includes receiving an eye-tracking data associated with a word. The eye-tracking data is received from a user device. The word is a portion of a digital document. The eye-tracking data comprises at least one fixation period of substantially seven-hundred and fifty milliseconds and at least one regression from another portion of the digital document to the word. A comprehension difficulty of the word is determined based on the eye-tracking data. One or more attributes to a user of the user device is assigned, by one or more processors based on the comprehension difficulty, wherein the one or more attributes are determined based on a meaning of the word. An implicit social graph is generated based on the one or more attributes.

### CROSS-REFERENCE TO RELATED APPLICATIONS

This application is a continuation-in-part of and claims priority from U.S. patent application Ser. No. 13/644,426 filed Oct. 4, 2012. U.S. patent application Ser. No. 13/644,426 is a continuation in part of and claims priority from U.S. application Ser. No. 13/076,346, filed Mar. 30, 2011, U.S. patent application Ser. No. 13/076,346 claims priority from U.S. Provisional Application No. 61/438,975, filed Feb. 3, 2011. This application claims priority from U.S. Provisional Application No. 61/696,994, filed Sep. 5, 2012. This application claims priority from U.S. Provisional Application No. 61/811,309, filed Apr. 12, 2013. This application claims priority from U.S. Provisional Application No. 61/681,514, filed Aug. 9, 2012. This application claims priority from U.S. Provisional Application No. 61/809,419, filed Apr. 8, 2013. These applications are hereby incorporated by reference in their entirety for all purposes. This application claims priority from U.S. Provisional Application No. 61/803,139, filed Mar. 19, 2013. These applications are hereby incorporated by reference in their entirety for all purposes.

### BACKGROUND OF THE INVENTION

1. Field

This application relates generally to identifying implicit social relationships from digital communication and biological responses (bioresponse) to digital communication, and more specifically to a system and method for generating an implicit social graph from biological responses to digital communication.

2. Related Art

Biological response (bioresponse) data is generated by monitoring a person's biological reactions to visual, aural, or other sensory stimuli. Bioresponse may entail rapid simultaneous eye movements (saccades), eyes focusing on a particular word or graphic for a certain duration, hand pressure on a device, galvanic skin response, or any other measurable biological reaction. Bioresponse data may further include or be associated with detailed information on what prompted a response. Eye-tracking systems, for example, may indicate a coordinate location of a particular visual stimuli—like a particular word in a phrase or figure in an image—and associate the particular stimuli with a certain response. This association may enable a system to identify specific words, images, portions of audio, and other elements that elicited a measurable biological response from the person experiencing the multimedia stimuli. For instance, a person reading a book may quickly read over some words while pausing at others. Quick eye movements, or saccades, may then be associated with the words the person was reading. When the eyes simultaneously pause and focus on a certain word for a longer duration than other words, this response may then be associated with the particular word the person was reading. This association of a particular word and bioresponse may then be analyzed.

Bioresponse data may be used for a variety of purposes ranging, from general research to improving viewer interaction with text, websites, or other multimedia information. In some instances, eye-tracking, data may be used to monitor a reader's responses while reading text. The bioresponse to the text may then be used to improve the reader's interaction with the text by, for example, providing definitions of words that the user appears to have trouble understanding.

Bioresponse data may be collected from a variety of devices and sensors that are becoming more and more prevalent today. Laptops frequently include microphones and high-resolution cameras capable of monitoring a person's facial expressions, eye movements, or verbal responses while viewing or experiencing media Cellular telephones now include high-resolution cameras, proximity sensors, accelerometers, and touch-sensitive screens (galvanic skin response) in addition to microphones and buttons, and these “smartphones” have the capacity to expand the hardware to include additional sensors. Moreover, high-resolution cameras are decreasing in cost making them prolific in a variety of applications ranging from user devices like laptops and cell phones to interactive advertisements in shopping malls that respond to mall patrons' proximity and facial expressions. The capacity to collect biological responses from people interacting with digital devices is thus increasing dramatically.

Interaction with digital devices has become more prevalent concurrently with a dramatic increase in online social networks that allow people to connect, communicate, and collaborate through the internet. Social networking sites have enabled users to interact through a variety of digital devices including traditional computers, tablet computers, and cellular telephones. Information about users from their online social profiles has allowed for highly targeted advertising and rapid growth of the utility of social networks to provide meaningful data to users based on user attributes. For instance, users who report an affinity for certain activities like mountain biking or downhill skiing may receive highly relevant advertisements and other suggestive data based on the fact that these users enjoy specific activities. In addition, users may be encouraged to connect and communicate with other users based on shared interests, adding further value to the social networking site, and causing users to spend additional time on the site, thereby increasing advertising revenue.

A social graph may be generated by social networking sites to define a user's social network and personal attributes. The social graph may then enable the site to provide highly relevant content for a user based on that user's interactions and personal attributes as demonstrated in the user's social graph. The value and information content of existing social graphs is limited, however, by the information losers manually enter into their profiles and the networks to which users manually subscribe. There is therefore a need and an opportunity to improve the quality of social graphs and enhance user interaction with social networks by improving the information attributed to given users beyond what users manually add to their online profiles.

Thus, a method and system are desired for using bioresponse data collected from prolific digital devices to generate an implicit social graph—including enhanced information automatically generated about users—to improve beyond existing explicitly generated social graphs that are limited to information manually entered by users.

### BRIEF SUMMARY OF THE INVENTION

In one exemplary embodiment, a computer-implemented method of generating an implicit social graph includes receiving an eye-tracking data associated with a word. The eye-tracking data is received from a user device. The word is a portion of a digital document. The eye-tracking data comprises at least one fixation period of substantially seven-hundred and fifty milliseconds and at least one regression from another portion of the digital document to the word. A comprehension difficulty of the word is determined based on the eye-tracking data. One or more attributes to a user of the user device is assigned, by one or more processors based on the comprehension difficult, wherein the one or more attributes are determined based on a meaning of the word. An implicit social graph is generated based on the one or more attributes.

Optionally, the method can further include providing a suggestion to the user, based on the implicit social graph. At least one of a suggestion of another user, a product, or an offer can be provided. A targeted advertisement can be provided to the user, based on the implicit social graph.

In another exemplary embodiment, a computer-implemented method of generating an implicit, social graph, the method includes receiving an eye-tracking data associated with a word, wherein the eye-tracking data is received from a user device. The word is a portion of a digital document. The eye-tracking data includes an initial fixation period of substantially twice a mean period of as specified number of preceding, words. A comprehension difficulty of the word is determined based on the eve-tracking data. One or more attributes are assigned to a user of the user device based on the comprehension difficulty. The one or more attributes are determined based on a meaning of the word. An implicit social graph is generated based on the one or more attributes.

Optionally, the eye-tracking data further can include a regressive fixation from another portion of the digital document to the word. The regressive fixation can occur at least five-hundred milliseconds after a termination of the initial fixation duration. The regressive fixation can occurs after at least one second after a termination of the initial fixation duration. The specified number of preceding words can include three words of at least four characters each.

### BRIEF DESCRIPTION OF THE DRAWINGS

The present application can be best understood by reference to the following description taken in conjunction with the accompanying figures, in which like parts may be referred to by like numerals.

FIG. 1 illustrates an exemplary process for generating an implicit social graph.

FIG. 2A illustrates an exemplary hypergraph indicating user attributes and attributes common to various users.

FIG. 2B illustrates an exemplary implicit social graph with weighted edges.

FIG. 3 illustrates user interaction with exemplary components that generate bioresponse data.

FIG. 4 illustrates exemplary components and an exemplary process for detecting eye-tracking data.

FIG. 5 illustrates an exemplary embodiment of a bioresponse data packet.

FIG. 6 illustrates an exemplary process for determining the significance of eye-tracking data and assigning attributes to a user accordingly.

FIG. 7 illustrates an exemplary text message on a mobile device with the viewer focusing on a visual component in the text message.

FIG. 8 illustrates an exemplary process for generating an implicit social graph from user attributes and for providing suggestions to users.

FIG. 9 illustrates a graph of communication among various users.

FIG. 10 illustrates a block diagram of an exemplary system for creating and managing an online social network using bioresponse data.

FIG. 11 illustrates a block diagram of an exemplary architecture of an embodiment of the invention.

FIG. 12 illustrates an exemplary distributed network architecture that may be used to implement a system for generating an implicit social graph from bioresponse data.

FIG. 13 illustrates a block diagram of an exemplary system for generating implicit social graph from bioresponse data.

FIG. 14 illustrates an exemplary computing system.

FIG. 15 depicts an example process of generating an implicit social graph, according to some embodiments.

FIG. 16 depicts an example process of generating an implicit social graph, according to some embodiments.

FIG. 17 depicts a process of generating a user cohort based on common selected user attributes as derived from eye-tracking data, according to some embodiments.

The Figures described above are a representative set, and are not an exhaustive with respect to embodying the invention.

### DETAILED DESCRIPTION OF THE INVENTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Process Overview

Disclosed are a system, method, and article of manufacture for generating an implicit social graph with bioresponse data Although the present embodiments have been described with reference to specific example embodiments, it will be evident that various modifications and changes may be made to these embodiments without departing from the broader spirit and scope of the various claims.

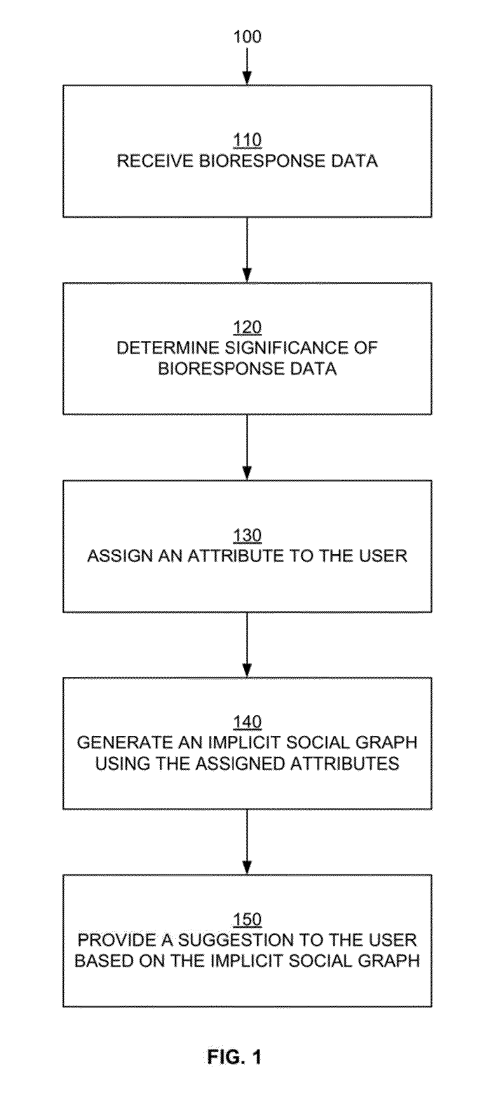

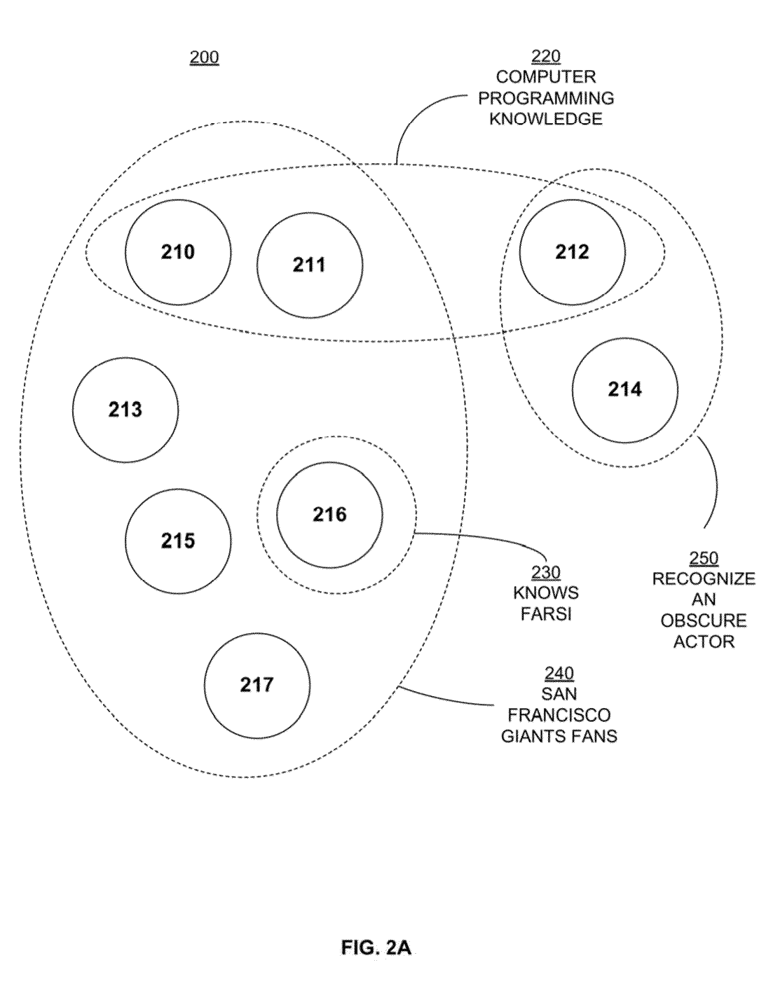

FIG. 1 illustrates an exemplary process for generating an implicit social graph and providing a suggestion to a user based cm the implicit social graph. In step 110 of process 100, bioresponse data is received. Bioresponse data may be any data that is generated by monitoring a user's biological reactions to visual, aural, or other sensory stimuli. For example, in one embodiment, bioresponse data may be obtained from an eye-tracking system that tracks eye-movement. However, bioresponse data is not limited to this embodiment. For example, bioresponse data may be obtained from had pressure, galvanic skin response, heart rate monitors, or the like. In one exemplary embodiment, a user may receive a digital document such as a text message on the user's mobile device. A digital document may include a text message (e.g., SMS, EMS, MMS, context-enriched text message, attentive (“@10tv”) text message or the like), web page element, image, video, or the like. An eye-tracking system on the mobile device may track the eye movements of the user, while viewing the digital document.

In step 120 of process 100, the significance of the bioresponse data is determined. In one embodiment, the received bioresponse data may be associated with portions of the visual, aural, or other sensory stimuli. For example, in the above eye-tracking, embodiment, the eye-tracking data may associate the amount of time, pattern of eye movement, or the like spent viewing each word with each word in the text message. This association may be used to determine a cultural significance, comprehension or lack thereof of the word, or the like.

In step 130 of process 100, an attribute is assigned to the user. The attribute may be determined based on the bioresponse data. For example, in the above eye-tracking embodiment, comprehension of a particular word may be used to assign an attribute to the user. For example, if the user understands the word “Python” in the text message “I wrote the code in Python,” then the user may be assigned the attribute of “computer programming knowledge.”

In step 140 of process 100, an implicit social graph is generated using the assigned attributes. Users are linked according to the attributes assigned in step 130. For example, all users with the attribute “computer programming knowledge” may be linked in the implicit social graph.

In step 150 of process 100, a suggestion may be provided to the user based on the implicit social graph. For example, the implicit social graph may be used to suggest contacts to a user, to recommend products or offers the user may find useful, or other similar suggestions. In one embodiment, a social networking site may communicate a friend suggestion to users who share a certain number of links or attributes. In another embodiment, a product, such as a book on computer programming, may be suggested to the users with a particular attribute, such as the “computer programming knowledge” attribute. One of skill in the art will recognize that suggestions are not limited to these embodiments. Information may be retrieved from the implicit social graph and used to provide a variety of suggestions to a user.

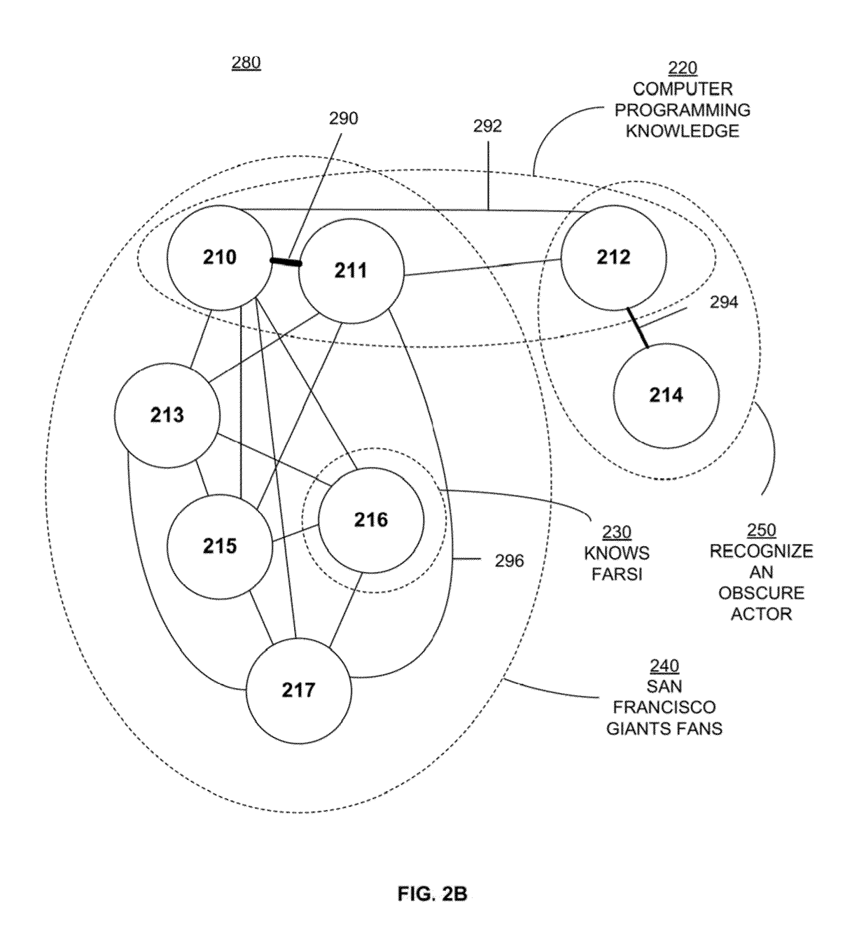

FIGS. 2A and 2B show a hypergraph 200 and an implicit social graph 280 of users 210-217 that may be constructed, from user relationships that indicate a common user attribute. In one embodiment, the attributes may be assigned as described in association with process 100 of FIG. 1. The user attributes may be determined from analysis of user bioresponses to visual, aural, or other sensory stimuli. In some embodiments, user attributes may be determined from user bioresponse data with regards to other sources such as web page elements, instant messaging terms, email terms, social networking status updates, microblog posts, or the like. For example, assume users 210, 211, 213, and 215-217 are all fans of the San Francisco Giants 240; users 210-212 have computer programming knowledge 220; users 212 and 214 recognize an obscure actor 250, and user 216 knows Farsi 230. These attributes 220, 230, 240, and 250 may be assigned to users 210-217 as shown in hypergraph 200.

A hypergraph 200 of users 210-217 may be used to generate an implicit social graph 280 in FIG. 2B. An implicit social graph 280 may be a social network that is defined by interactions between users and their contacts or between groups of contacts. In some embodiments, the implicit social graph 280 may be used by an entity such as a social networking website to perform such operations as suggesting contacts to a user, presenting advertisements to a user, or the like.

In some embodiments, the implicit social graph 280 may be a weighted graph, where edge weights are determined by such values as the bioresponse data that indicates a certain user attribute (e.g., eye-tracking data that indicates a familiarity (or a lack of familiarity) with a certain concept or entity represented by a visual component). One exemplary quantitative metric for determining an edge weight between two user nodes with bioresponse data may include measuring the number of common user attributes shared between two users as determined by an analysis of the bioresponse data For example, users with two common attributes, such as users 210 and 211, may have a stronger weight for edge 290 than users with a single common attribute, such as users 210 and 212. In this embodiment, the weight of edge 292 may have a lower weight than the weight of edge 290. In another example, a qualitative metric may be used to determine an edge weight. For example, a certain common attribute (e.g., eye-tracking data indicating a user recognizes an obscure actor) may have a greater weight than a different common attribute (e.g., eye-tracking data that indicates a sports team preference of the user). In this embodiment, the weight of edge 294, indicating users 212 and 214 both recognize an obscure actor, may be weighted more heavily than the weight of edge 296, indicating users 211 and 217 are both San Francisco Giants fans.

It should be noted that, in addition to bioresponse data, other values may also be used to construct the implicit social graph. For example, edge weights of the implicit social graph may be weighted by the frequency, recency, or direction of interactions between users and other contacts, groups in a social network, or the like. In some example embodiments, context data of a mobile device of a user may also be used to weigh the edge weights of the implicit social graph. Also, in some embodiments, the content of a digital document (e.g., common term usage, common argot, common context data if a context-enriched message) may be analyzed to generate an implicit social graph. Further, the implicit social graph may change and evolve over time as more data is collected from the user. For example, at one point in time, a user may not be a San Francisco Giants fan. However, some time later, the user may move to San Francisco and begin to follow the team. At this point, the user's preferences may change and the user may become a San Francisco Giants fan. In this example, the implicit social graph may change to include this additional attribute.

Returning to FIG. 1, each step will now be described in more detail.

### Receive Bioresponse Data

In step 110 of process 100, bioresponse data is received. When a user is viewing data on a user device, bioresponse data may be collected. The viewed data may take the form of a text message, webpage element, instant message, email, social networking status update, micro-blog post, blog post, video, image, or any other digital document. The bioresponse data may be eye-tracking data, bean rate data, hand pressure data, galvanic skin response data, or the like. A webpage element may be any element of a web page document that is perceivable by a user with a web browser on the display of a computing, device.

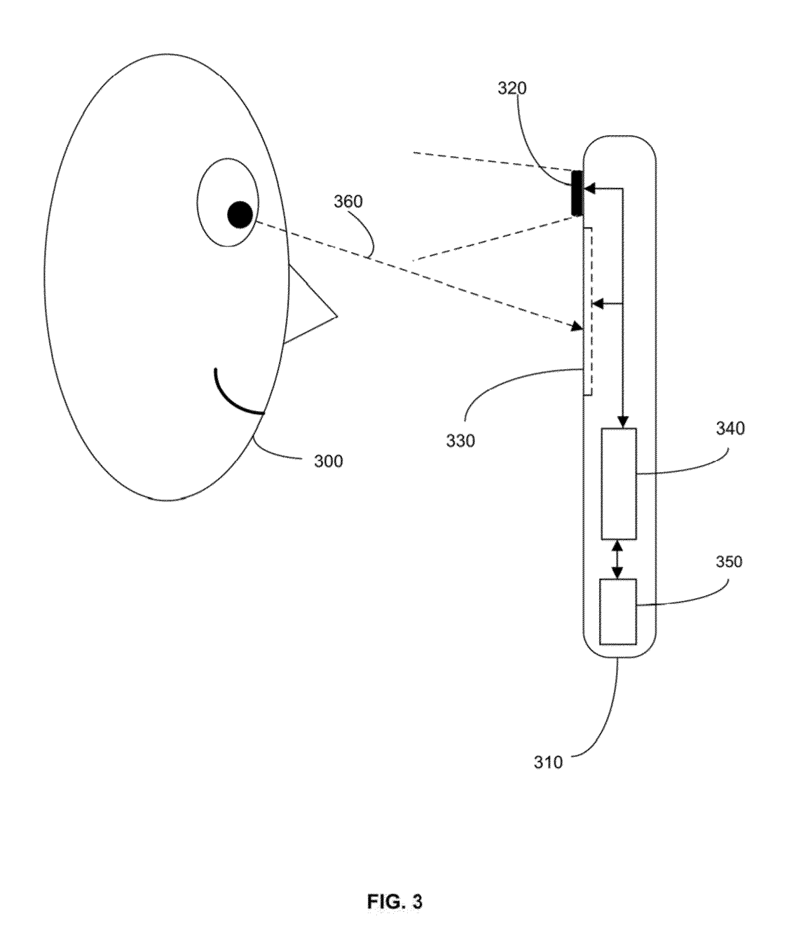

FIG. 3 illustrates one example of obtaining bioresponse data from a user viewing a digital document. In this embodiment, eye-tracking module 340 of user device 310 tracks the gaze 360 of user 300. Although illustrated here as a generic user device 310, the device may be a cellular telephone, personal digital assistant, tablet computer (such as an iPad®), laptop computer, desktop computer, or the like. Eye-tracking module 340 may utilize information from at least one digital camera 320 and/or an accelerometer 350 (or similar device that provides positional information of user device 310) to track the user's gaze 360. Eye-tracking module 340 may map eye-tracking data to information presented on display 330. For example, coordinates of display information may be obtained from a graphical user interface (GUI). Various eye-tracking algorithms and methodologies (such as those described herein) may be utilized to implement the example shown in FIG. 3.

In some embodiments, eye-tracking module 340 may utilize an eye-tracking method to acquire the eye movement pattern. In one embodiment, an example eye-tracking method may include an analytical gaze estimation algorithm that employs the estimation of the visual direction directly from selected eye features such as irises, eye corners, eyelids, or the like to compute a gaze 360 direction. If the positions of any two points of the nodal point, the fovea, the eyeball center or the pupil center can be estimated, the visual direction may be determined.

In addition, a light may be included on the from side of user device 310 to assist detection of any points hidden in the eyeball. Moreover, the eyeball center may be estimated from other viewable facial features indirectly. In one embodiment, the method may model an eyeball as a sphere and hold the distances from the eyeball center to the two eye corners to be a known constant. For example, the distance may be fixed to 13 mm. The eye corners may be located (for example, by using a binocular stereo system) and used to determine the eyeball center. In one exemplary embodiment, the iris boundaries may be modeled as circles in the image using a Hough transformation.

The center of the circular iris boundary may then be used as the pupil center. In other embodiments, a high-resolution camera and other image processing tools may be used to detect the pupil. It should be noted that, in some embodiments, eye-tracking module 340 may utilize one or more eye-tracking methods in combination. Other exemplary eye-tracking methods include: a 2D eye-tracking algorithm using a single camera and Purkinje image, a real-time eye-tracking algorithm with head movement compensation, a real-time implementation of a method to estimate gaze 360 direction using stereo vision, a free head motion remote eyes (REGT) technique, or the like. Additionally, any combination of any of these methods may be used.

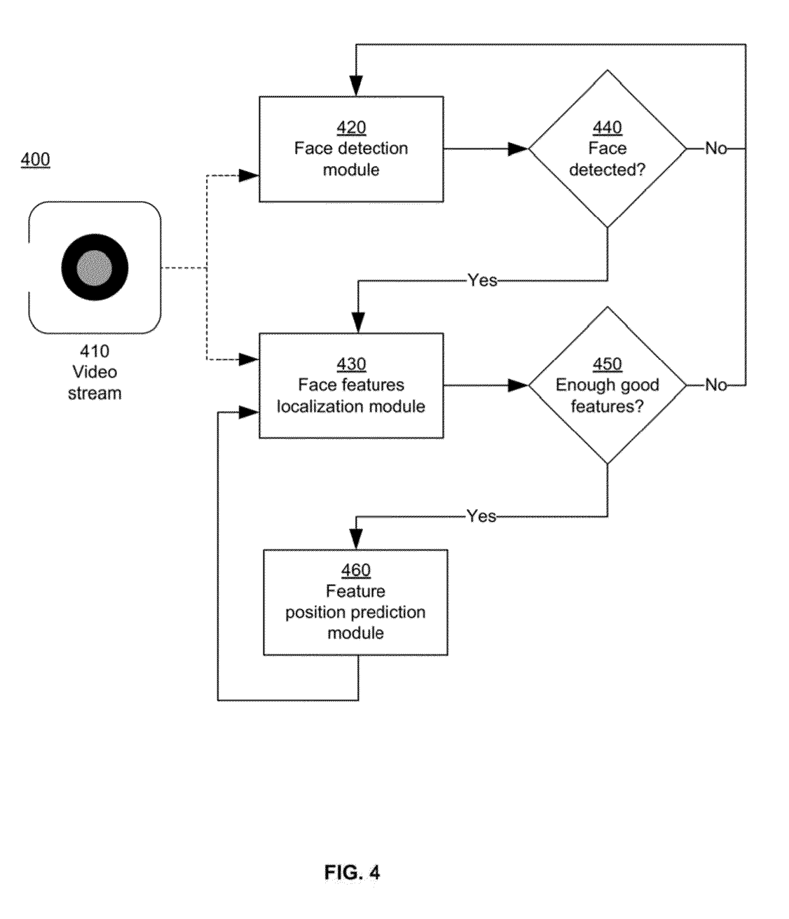

FIG. 4 illustrates exemplary components and an exemplary process 400 for detecting eye-tracking data The gaze-tracking algorithm discussed above may be built upon three modules which intemperate to provide a fast and robust eyes- and face-tracking system. Data received from video stream 410 may be input into face detection module 420 and face feature localization module 430. Face detection module 420, at junction 440, may check whether a face is present in front of the camera, receiving video stream 410.

When implemented using the OpenCV library, if no previous eye position from preceding frames is known, the input image may first be scanned for possible circles, using an appropriately adapted Hough algorithm. To speed up operation, an image of reduced size may be used in this step. In one embodiment, limiting the Hough parameters (for example, the radius) to a reasonable range provides additional speedup. Next, the detected candidates may be checked against further constraints like a suitable distance of the pupils and a realistic roll angle between them. If no matching pair of pupils is found, the image may be discarded. For successfully matched pairs of pupils, sub-images around the estimated pupil center may be extracted for further processing. Especially due to interlace effects, but also caused by other influences the pupil center coordinates, pupils found by the initial Hough algorithm may not be sufficiently accurate for further processing. For exact calculation of gaze 360 direction, however, this coordinate should be as accurate as possible.

One possible approach for obtaining a usable pupil center estimation is actually finding the center of the pupil in an image. However, the invention is not limited to this embodiment. In another embodiment, for example, pupil center estimation may be accomplished by finding the center of the iris, or the like. While the iris provides a larger structure and thus higher stability for the estimation, it is often partly covered by the eyelid and thus not entirely visible. Also, its outer bound does not always have a high contrast to the surrounding parts of the image. The pupil, however, can be easily spotted as the darkest region of the (sub-)image.

Using, the center of the Hough-circle as a base, the surrounding dark pixels may be collected to form the pupil region. The center of gravity for all pupil pixels may be calculated and considered to be the exact eye position. This value may also form the starting point for the next cycle. If the eyelids are detected to be closed during this step, the image may be discarded. The radius of the iris may now be estimated by looking for its outer bound. This radius may later limit the search area for glints. An additional sub-image may be extracted from the eye image, centered on the pupil center and slightly larger than the iris. This image may be checked for the corneal reflection using a simple pattern matching approach. If no reflection is found, the image may be discarded. Otherwise, the optical eye center may be estimated and the gaze 360 direction may be calculated. It may then be intersected, with the monitor plane to calculate the estimated viewing point. These calculations may be done for both eyes independently. The estimated viewing point may then be used for further processing. For instance, the estimated viewing point can be reported to the window management system of a user's device as mouse or screen coordinates, thus providing a way to connect the eye-tracking method discussed herein to existing software.

A user's device may also include other eye-tracking methods and systems such as those included and/or implied in the descriptions of the various eye-tracking operations described herein. In one embodiment, the eye-tracking system may include an external system (e.g., a Tobii T60 XL eye tracker, Tobii TX 300 eye tracker or similar eye-tracking system) communicatively coupled (e.g., with a USB cable, with a short-range Wi-Fi connection, or the like) with the device. In other embodiments, eve-tracking systems may be integrated into the device. For example, the eye-tracking system may be integrated as a user-facing camera with concomitant eye-tracking utilities installed in the device.

In one embodiment, the specification of the user-facing camera may be varied according to the resolution needed to differentiate the elements of a displayed message. For example, the sampling rate of the user-facing camera may be increased to accommodate a smaller display. Additionally, in some embodiments, more than one user-facing camera (e.g., binocular tracking) may be integrated into the device to acquire more than one eve-tracking sample. The user device may include image processing utilities necessary to integrate the images acquired by the user-facing camera and then map the eye direction and motion to the coordinates of the digital document on the display. In some embodiments, the user device may also include a utility for synchronization of gaze data with data from other sources, e.g., accelerometers, gyroscopes, or the like. In some embodiments, the eye-tracking method and system may include other devices to assist in eye-tracking operations. For example, the user device may include a user-facing infrared source that may be reflected from the eye and sensed by an optical sensor such as a user-facing camera.

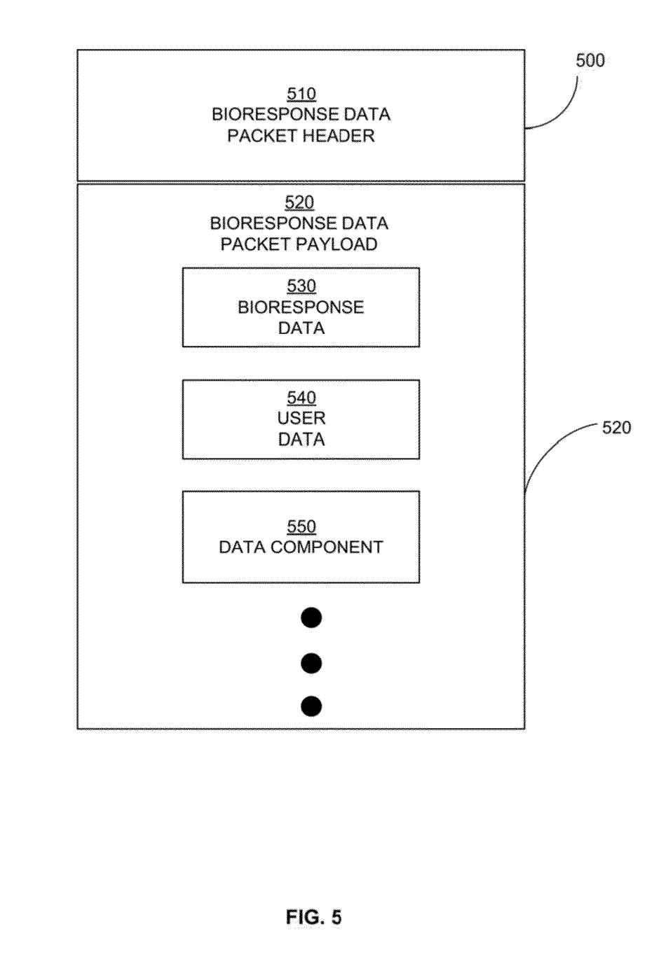

Irrespective of the particular eye-tracking methods and systems employed, and even if bioresponse data other than eye-tracking, is collected for analysis, the bioresponse data may be transmitted in a format similar to the exemplary bioresponse data packet 500 illustrated in FIG. 5. Bioresponse data packet 500 may include bioresponse data packet header 510 and bioresponse data packet payload 520. Bioresponse data packet payload 520 may include bioresponse data 530 (e.g., eye-tracking data) and user data 540. User data 540 may include data that maps bioresponse data 530 to a data component 550 in a digital document. However, the invention is not limited to this embodiment. For example, user data 540 may also include data regarding the user or device. For example, user data 540 may include user input data such as name, age, gender, hometown or the like. User data 540 may also include device information regarding the global position of the device, temperature, pressure, time, or the like. Bioresponse data packet payload 520 may also include data component 550 with which the bioresponse data is mapped. Bioresponse data packet 500 may be formatted and communicated according to an IP protocol. Alternatively, bioresponse data packet 500 may be formatted for any communication system, including, but not limited to, an SMS, EMS, MMS, or the like.

### Determine Significance of Bioresponse Data

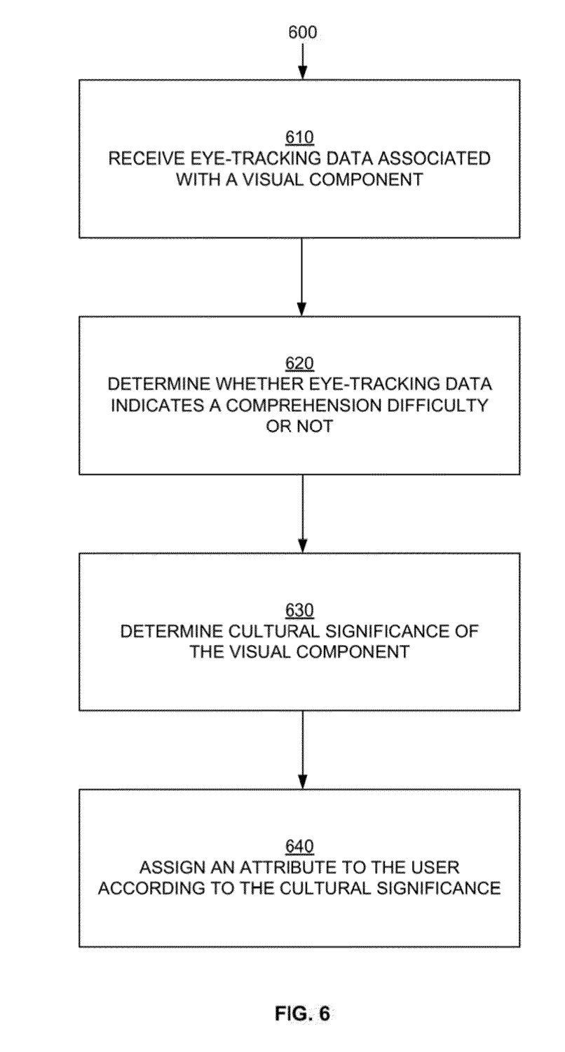

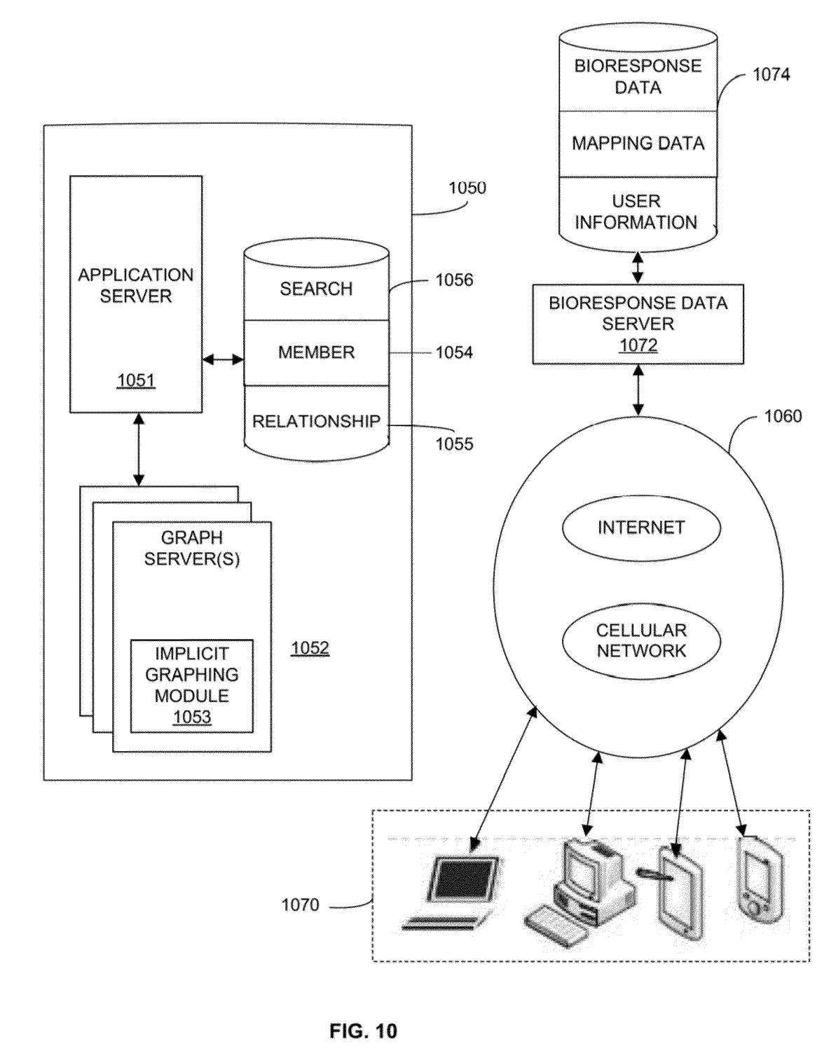

Returning again to FIG. 1 and process 100 for generating an implicit social graph, after bioresponse data is received and analyzed in step 110, the significance of the bioresponse data is determined in step 120. FIG. 6 illustrates one embodiment of an exemplary process for determining the significance of one type of bioresponse data, eye-tracking data, and assigning attributes to a user accordingly. In step 610 of process 600, eye-tracking data associated with a visual component is received. The eye-tracking, data may indicate the eye movements of the user. For example, implicit graphing module 1053 (shown in FIG. 10) may receive the eye-tracking data associated with a visual component. The visual component may be a component of a digital document, such as a text component of a text message, an image on a webpage, or the like.

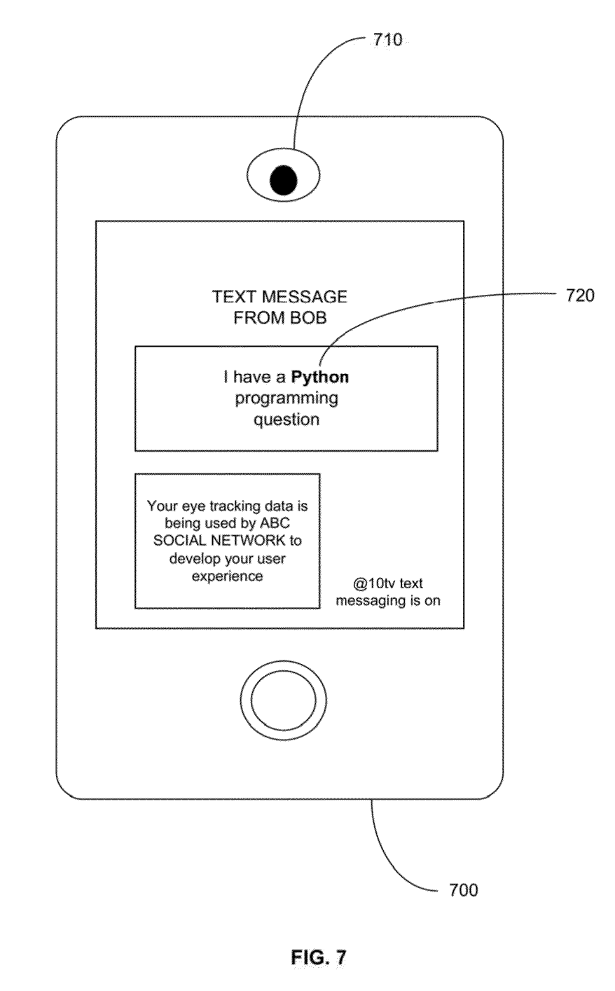

FIG. 7 illustrates a text message on mobile device 700 with the viewer focusing on visual component 720 in the text message. In some embodiments, mobile device 700 may include one or more digital cameras 710 to track eye movements. For example, mobile device 700 may include digital camera 710. In one embodiment, mobile device 700 may include at least two stereoscopic digital cameras, in some embodiments, mobile device 700 may also include as light source that can be directed at the eyes of the user to illuminate at least one eye of the user to assist in a gaze detection operation. In some embodiments, mobile device 700 may include a mechanism for adjusting the stereo base distance according to the user's location, distance between the user's eyes, user head motion, or the like to increase the accuracy of the eye-tracking data. In some embodiments, the size of the text message, text-message presentation box, or the like may also be adjusted to facilitate increased eye-tracking accuracy.

Referring again to FIG. 6, in step 620 of process 600, implicit graphing module 1053 (shown in FIG. 10) may determine whether the eye-tracking data indicates a comprehension difficulty on the part of a user with regards to the visual component. For example, in one embodiment, implicit graphing module 1053 may determine whether a user's eyes (or gaze) linger on a particular location. This lingering may indicate a lack of comprehension of the visual component. In another embodiment, multiple regressions, fixations of greater than a specified time period (e.g., 0.75 ms), or the like may indicate comprehension difficulty.

Referring again to FIG. 7, an example text message is presented on the display of mobile device 700. The eye-tracking system may determine that the user's eyes are directed at the display. The pattern of the eye's gaze on the display may then be recorded. The pattern may include such phenomena as fixations, saccades, regressions, or the like. In some embodiments, the period of collecting eye-tracking data may be a specified time period. This time period may be calculated based on the length of the message. For example, in one embodiment, the collection period may last a specific period of time per word, e.g., 0.5 seconds per word. In this embodiment, for a six-word message, the collection period may last 3 seconds. However, the invention is not limited to this embodiment. One of ordinary skill in the art would understand that different time periods may apply. For example, the collection period may be 0.25 seconds per word, a predetermined period of time, based on an average time to read a message of similar length, or the like. The gaze pattern for a particular time period may thus be recorded and analyzed.

Referring again to FIG. 6, in step 630 of process 600, a cultural significance of the visual component may be determined from the eye-tracking data. In one embodiment, various visual components may be associated with various cultural attributes in a table, relational database, or the like maintained by a system administrator of such a system. Cultural significance may include determining a set of values, conventions, or social practices associated with understanding or not understanding the particular visual component, such as text, an image, a web page element, or the like. Moreover, eye-tracking data may indicate a variety of other significant user attributes including preference for a particular design, comprehension of organization or structure, ease of understanding certain visual components, or the like.

Additionally, one of ordinary skill in the art will appreciate that the significance of eye-tracking data or any bioresponse data may extend beyond comprehension of terms and images and may signify numerous other user attributes. For instance, bioresponse data may indicate an affinity for a particular image and its corresponding, subject matter, a preference for certain brands, a preferred pattern or design of visual components, and many other attributes. Accordingly, bioresponse data, including eye-tracking, may be analyzed to determine the significance, if any, of a user's biological response to viewing various visual components.

Process 100 of FIG. 1 is not limited to the specific embodiment of eye-tracking data derived from text messages describe above. In another embodiment using eye-tracking data, a user may view a webpage. The elements of the webpage, such as text, images, videos, or the like, may be parsed from the webpage. The eye-tracking data may then be mapped to the webpage elements by comparing, for example, their coordinates. From the eye-tracking data, comprehension difficulty, areas of interest, or the like may be determined. Further, the cultural significance of the webpage elements, including, but not limited to, their semantics may be determined. One or more attributes may be determined from this data, in a manner described below.

### Assign an Attribute to the User

Returning again to FIG. 1 and process 100 for generating an implicit social graph, once the significance of bioresponse data is determined in step 120, process 100 continues with step 130 by assigning an attribute to the user. Referring again to FIG. 6 and process 600 using the example of eye-tracking data to indicate comprehension, after the cultural significance of a visual component is determined in step 630, process 600 continues with step 640 by assigning an attribute to the user according to the cultural significance of the visual component. In step 640, a table, relational database, or the like may also be used to assign an attribute to the user according to the cultural significance. In another embodiment, implicit social graphing module 1053 (shown in FIG. 10) may perform these operations. Referring again to FIG. 7, for example, a user's gaze may linger on the word. “Python” longer than a specified time period. In this particular message, the word “Python” has a cultural significance indicating a computer programming language known to the set of persons having the attribute of “computer programming knowledge.” Implicit social graphing, module 1053 may use this information to determine that the reader does or does not have the attribute of being a computer programmer. For example, if the eye-tracking data indicates no lingering on the word “Python,” implicit social graphing module 1053 may indicate no comprehension difficulty for the term in the same textual context. Implicit social graphing module 1053 may then assign the attribute of “computer programming knowledge” to the reader. Alternatively, if the eye-tracking data indicates lingering, on the word “Python,” implicit social graphing module 1053 may indicate comprehension difficultly. Implicit social graphing module 1053 may then not assign the attribute of “computer programming knowledge” to the user, or may assign a different attribute, such as “lacks computer programming knowledge” to the user.

In other examples, eye-tracking data may be obtained for argot terms of certain social and age groups, jargon for certain professions, non-English language words, regional terms, or the like. A user's in-group status may then be assumed from the existence or non-existence of a comprehension difficulty for the particular term. In still other examples, eye-tracking data for images of certain persons, such as a popular sports figure, may be obtained. The eye-tracking data may then be used to determine a familiarity or lack of familiarity with the person. If a familiarity is determined for the athlete, then, for example, the user may be assigned the attribute of a fan of the particular athlete's team. However, the embodiments are not limited by these specific examples. One of ordinary skill in the art will recognize that there are other ways to determine attributes for users.

Further, in another embodiment, other types of bioresponse data besides eye-tracking may be used. For example, while viewing a digital document, galvanic skin response may be measured. In one embodiment, the galvanic, skin response may measure skin conductance, which may provide information related to excitement and attention. If a user is viewing a digital document such as a video, the galvanic skin response may indicate a user's interest in the content of the video. If the user is excited or very interested in a video about, for example, computer programming, the user may then be assigned the attribute “computer programming knowledge.”If a user is not excited or pays little attention to the video, the user may not be assigned this attribute.

In some embodiments, the operations of FIG. 6 may also be performed by other elements of a social network management system (such as system 1050 depicted in FIG. 10 and described below). Other elements may include bioresponse data server 1072 (shown in FIG. 10), a bioresponse module of a device, or the like. The information may then be communicated to implicit graphing module 1053 (shown in FIG. 10). Therefore, bioresponse data—such as eye-tracking data—indicating a culturally significant attribute may be used to assign attributes to a user.

Generate an Implicit Social Graph using the Assigned Attributes

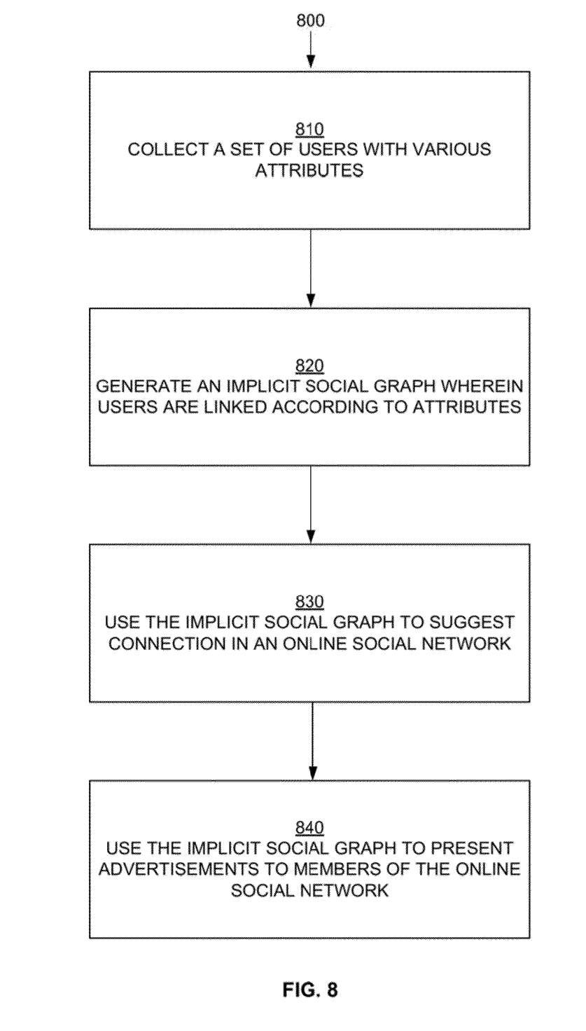

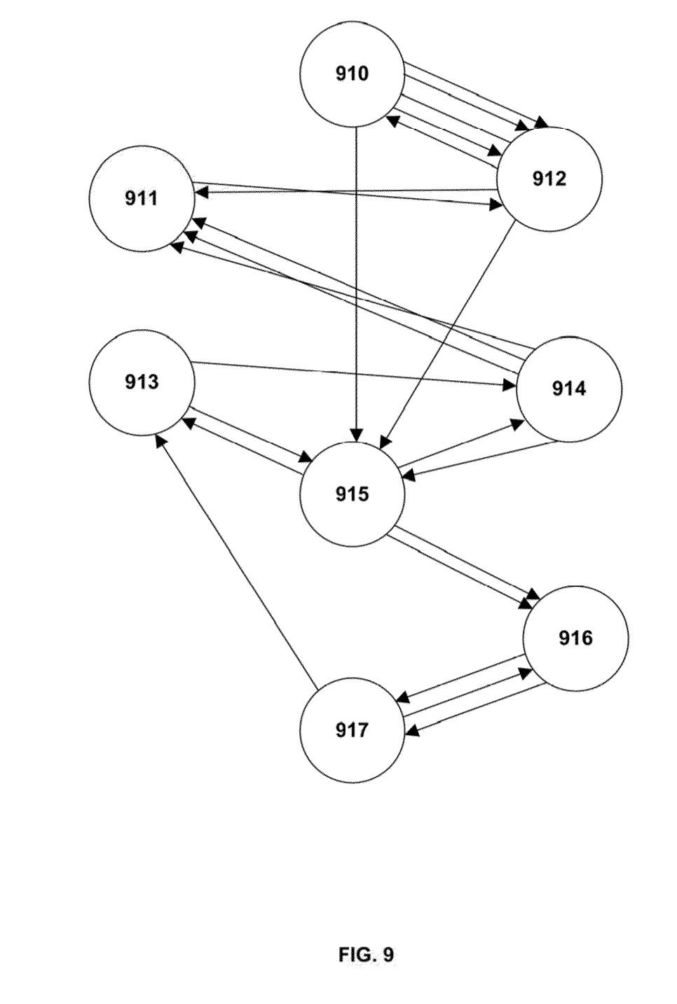

Returning again to FIG. 1 and process 100, once an attribute has been assigned to the user in step 130, process 100 continues with step 140 to generate an implicit social graph using the assigned attributes. FIG. 8 illustrates an exemplary process 800 for generating an implicit social graph from user attributes and for providing, suggestions to the user. In step 810 of process 800, a set of users with various attributes may be collected. In some embodiments, step 810 may be implemented with the data obtained from the operations of FIG. 6. The operations of FIG. 6 may be performed multiple times for multiple users. For example, FIG. 9 shows a graph composed of user nodes 910-917 connected by arrowed lines. Each user node may represent a distinct user (e.g., user 910, user 911, user 912, etc.). The arrowed lines may indicate the transmission of a digital document from one user to another (e.g., from user 910 to user 912, from user 917 to user 913, etc.). For each arrowed line, the process of FIG. 6 may be performed to assign one or more attributes to a user.

After a set of users is collected in step 810 of process 800, the set of users may be linked according to their attributes in step 820 to generate a hypergraph, such as the graph described in accordance with FIG. 2A. From the hypergraph, an implicit social graph may be generated, such as the implicit social graph described in accordance with FIG. 2B. For example, users 210, 211, and 212 depicted in FIG. 2 may be linked, according, to the “computer programming knowledge” attribute 220. The implicit social graph is not, however, limited to this embodiment. One of ordinary skill in the art will recognize that many variations of attributes and links may exist among the various users to categorize and organize various users to generate an implicit social graph based on user attributes.

### Provide a Suggestion to the User Based on the Implicit Social Graph

Returning again to FIG. 1 and process 100, once an implicit social graph has been generated in step 140, process 100 may continue with step 150 to provide a suggestion to the user based on the implicit social graph. In one embodiment, referring again to FIG. 8 and process 800, the implicit social graph may be used in step 830 to provide a social network connection suggestion to the user. For example, in one embodiment, the implicit social graph may be used by an entity such as a social networking website to suggest contacts to a user, to recommend products or offers the user may find useful, or other similar suggestions. In another embodiment, a social network may communicate a friend suggestion to users who share a certain number of links or attributes. For instance, referring to the exemplary implicit social graph in FIG. 2B, users 210 and 211 both exhibit attributes 220 and 240. A social network may therefore use the social graph to suggest that users 210 and 211 connect online if not already connected.

Referring again to FIG. 8, in step 840 of process 800, the implicit social graph may also be used to provide an advertisement to the user based on the implicit social graph. The advertisement may be targeted to the user based on attributes identified in any of the preceding, processes, including process 600 of FIG. 6. For example, books on computer programming may be advertised to those users with the “computer programming knowledge” attribute.

Not all steps described in process 800 are necessary to practice an exemplary embodiment of the invention. Many of the steps are optional, including, for example, steps 830 and 840. Moreover, step 840 may be practiced without requiring step 830, and the order as depicted in FIG. 8 is only an illustrative example and may be modified. Further, the suggestion in step 830 and the advertisement in step 840 may be determined, based on other information in addition to the implicit social graph. For example, the implicit social graph may be incorporated into an explicit social network. In one embodiment, an explicit social network is built based on information provided by the user, such as personal information (e.g., age, gender, hometown, interests, or the like), user connections, or the like.

Furthermore, information provided by one or more sensors on the user's device may be used to provide suggestions or advertisements to the user. For example, in one embodiment, a barometric pressure sensor may be used to detect if it is raining or about to rain. This information may be combined with the implicit social network to provide a suggestion to the user. For example, a suggestion for a store selling umbrellas or a coupon for an umbrella may be provided to the user. The store may be selected by determining the shopping preferences of the users who share several attributes with the user. One of ordinary skill in the art will recognize that the invention is not limited to this embodiment. Many various sensors and combinations may be used to provide a suggestion to a user.

Therefore, bioresponse data may signify culturally significant attributes that may be used to generate an implicit social graph that, alone or in combination with other information sources, may be used to provide suggestions to a user.

### System Architecture

FIG. 10 illustrates a block diagram of an exemplary system 1050 for creating and managing an online social network using bioresponse data. As shown, FIG. 10 illustrates system 1050 that includes application server 1051 and one or more graph servers 1052. System 1050 may be connected to one or more networks 1060, e,g., the Internet, cellular networks, as well as other wireless networks, including, but riot limited to, LANs, WANS, or the like. System 1050 may be accessible over the network by a plurality of computing devices 1070. Application server 1051 may manage member database 1054, relationship database 1055, and search database 1056. Member database 1054 may contain profile information for each of the members in the online social network managed by system 1050.

Profile information in member database 1054 may include, for example, a unique member identifier, name, age, gender, location, hometown, or the like. One of ordinary skill in the art will recognize that profile information is not limited to these embodiments. For example, profile information may also include references to image files, listing, of interests, attributes, or the like. Relationship database 1055 may store information defining first degree relationships between members. In addition, the contents of member database 1054 may be indexed and optimized for search, and may be stored in search database 1056. Member database 1054, relationship database 1055, and search database 1056 may be updated to reflect inputs of new member information and edits of existing member information that are made through computers 1070.

The application server 1051 may also manage the information exchange requests that it receives from the remote devices 1070. The graph servers 1052 may receive a query from the application server 1051, process the query and return the query results to the application server 1051. The graph servers 1052 may manage a representation of the social network for all the members in the member database. The graph servers 1052 may have a dedicated memory device, such as a random access memory (RAM), in which an adjacency list that indicates all first degree relationships in the social network is stored. The graph servers 1052 may respond to requests from application server 1051 to identify relationships and the degree of separation between members of the online social network.

The graph servers 1052 may include an implicit graphing module 1053. Implicit graphing module 1053 may obtain bioresponse data (such as eye-tracking data, hand-pressure, galvanic skin response, or the like) from a bioresponse module (such as, for example, attentive messaging module 1318 of FIG. 13) in devices 1070, bioresponse data server 1072, or the like. For example, in one embodiment, eye-tracking data of a text message viewing session may be obtained along with other relevant information, such as the identification of the sender and reader, time stamp, content of text message, data that maps the eye-tracking data with the text message elements, or the like.

A bioresponse module may be any module in a computing device that can obtain a user's bioresponse to a specific component of a digital document such as a text message, email message, web page document, instant message, microblog post, or the like. A bioresponse module may include a parser that parses the digital document into separate components and may indicate a coordinate of the component on a display of devices 1070. The bioresponse module may then map the bioresponse to the digital document component that evoked the bioresponse. For example, in one embodiment, this may be performed with eye-tracking data that determines which digital document component is the focus of a user's attention when a particular bioresponse was recorded by a biosensor(s) (e.g., an eye-tracking system) of the devices 1070. This data may be communicated to the implicit graphing module 1053, the bioresponse data server 1072, or the like.

Implicit graphing module 1053 may use bioresponse data and concomitant digital document component used to generate the set of user attributes obtained from a plurality of users of the various devices communicatively coupled to the system 1050. In some embodiments, the graph servers 1052 may use the implicit social graph to respond to requests from application server 1051 to identify relationships and the degree of separation between members of an online social network.

The digital documents may originate from other users and user bioresponse data may be obtained by implicit graphing module 1053 to dynamically create the implicit social graph from the users' current attributes. In one embodiment, implicit graphing module 1053 may send specific, types of digital documents with terms, images, or the like designed to test a user for a certain attribute to particular user devices to acquire particular bioresponse data from the user. Additionally, implicit social graphing module 1053 may also communicate instructions to a bioresponse module to monitor certain terms, images, classes of terms or images, or the like.

In some embodiments, communication network 1076 may support protocols used by wireless and cellular phones, personal email devices, or the like. Furthermore, in some embodiments, communication network 1060 may include an internet-protocol (IP) based network such as the Internet. A cellular network may include a radio network distributed over land areas called cells, each served by at least one fixed-location transceiver known as to cell site or base station. A cellular network may be implemented with a number of different digital cellular technologies. Cellular radiotelephone systems offering mobile packet data communications services may include GSM with GPRS systems (GSM/GPRS), CDMA/1xRTT systems, Enhanced Data Rates for Global Evolution (EDGE) systems, EV-DO systems, Evolution For Data and Voice (EV-DV) systems, High Speed Downlink Packet Access (HSDPA) systems, High Speed Uplink Packet Access (HSUPA), 3GPP Long Term Evolution (LTE), or the like.

Bioresponse data server 1072 may receive bioresponse and other relevant data (such as, for example, mapping data that may indicate the digital document component associated with the bioresponse and user information) from the various bioresponse modules of FIG. 10. In some embodiments, bioresponse data server 1072 may perform additional operations on the data such as normalization and reformatting so that the data may be compatible with system 1050, a social networking system, or the like. For example, in one embodiment, bioresponse data may be sent from a Mobile device in the form of a concatenated. SMS message. Bioresponse data server 1072 may normalize the data and reformat it into IP data packets and then may forward the data to system 1050 via the Internet.

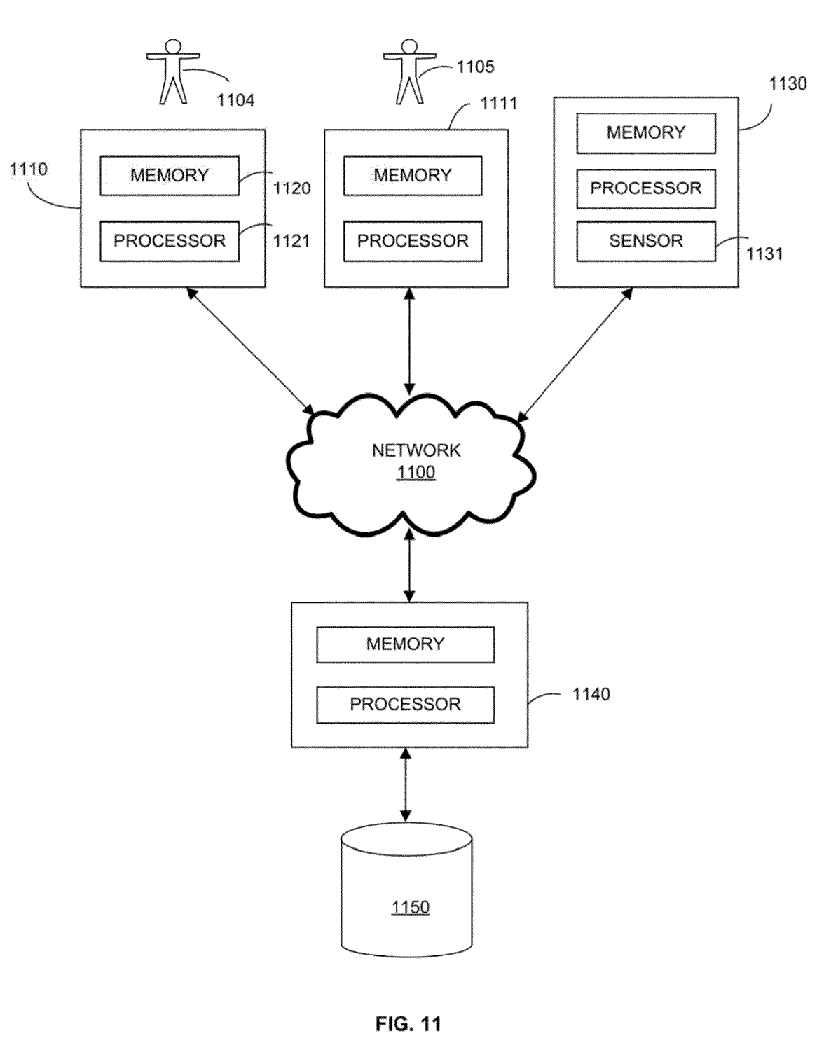

FIG. 11 is a diagram illustrating an architecture in which one or more embodiments may be implemented. The architecture includes multiple client devices 1110-1111, remote sensor(s) 1130, a server device 1140, a network. 1100, and the like. Network 1100 may be, for example, the Internet, a wireless network, a cellular network, or the like. Client devices 1110-1111 may each include a computer-readable medium, such as random access memory, coupled to a processor 1121. Processor 1121 may execute program instructions stored in memory 1120. Client devices 1110-1111 may also include a number of additional external or internal devices, including, but not limited to, a mouse, a CD-ROM, a keyboard, a display, or the like. Thus, as will be appreciated by those skilled in the an, the client devices 1110-1111 may be personal computers, personal digital assistants, mobile phones, content players, tablet computers (e.g., the iPad® by Apple Inc.), or the like.

Through client devices 1110-1111, users 1104-1105 may communicate over network 1100 with each other and with other systems and devices coupled to network 1100, such as server device 1140, remote sensors, smart devices, third-party servers, or the like. Remote sensor 1130 may be a client device that includes a sensor 1131. Remote sensor 1130 may communicate with other systems and devices coupled to network 1100 as well. In some embodiments, remote sensor 1130 may be used to acquire bioresponse data, client device context data, or the like.

Similar to client devices 1110-1111, server device 1140 may include a processor coupled to a computer-readable memory. Client processors 1121 and the processor for server device 1140 may be any of a number of well known microprocessors. Memory 1120 and the memory for server 1140 may contain a number of programs, such as the components described in connection with the invention. Server device 1140 may additionally include a secondary storage element 1150, such as a database. For example, server device 1140 may include one or more of the databases shown in FIG. 10, such as relationship database 1055, member database 1054, search database 1056, or the like.

Client devices 1110-1111 may be any type of computing platform that may be connected to a network and that may interact with application programs. In some example embodiments, client devices 1110-1111, remote sensor 1130 and/or server device 1140 may be virtualized. In some embodiments, remote sensor 1130 and server device 1140 may be implemented as a network of computers and/or computer processors.

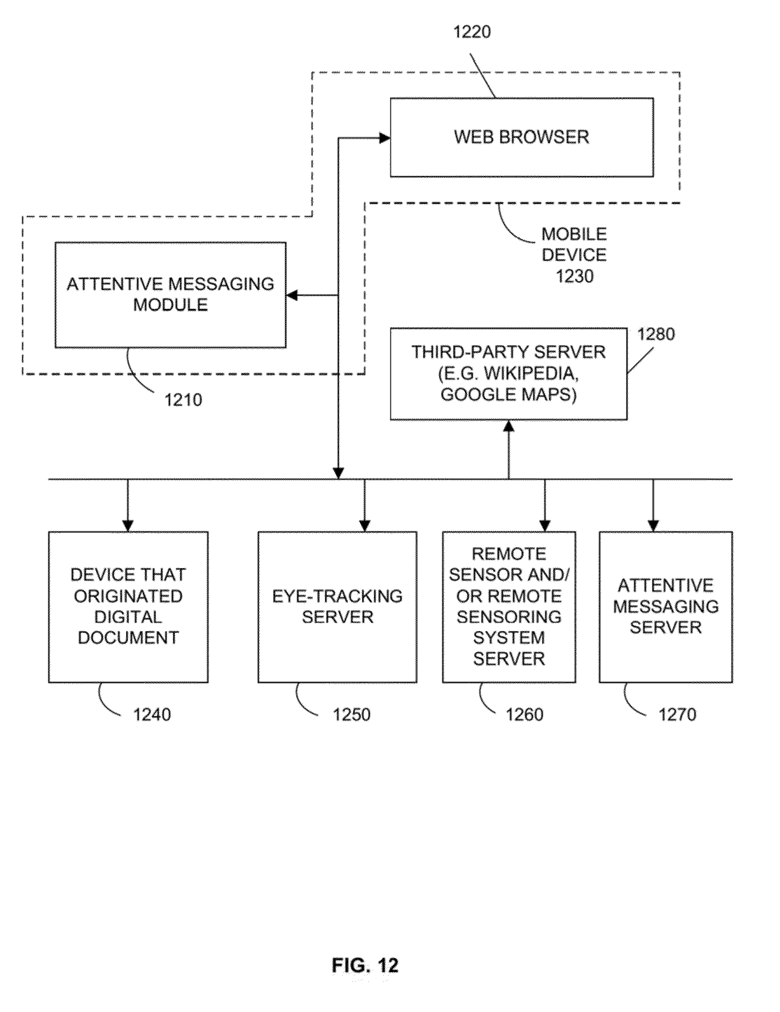

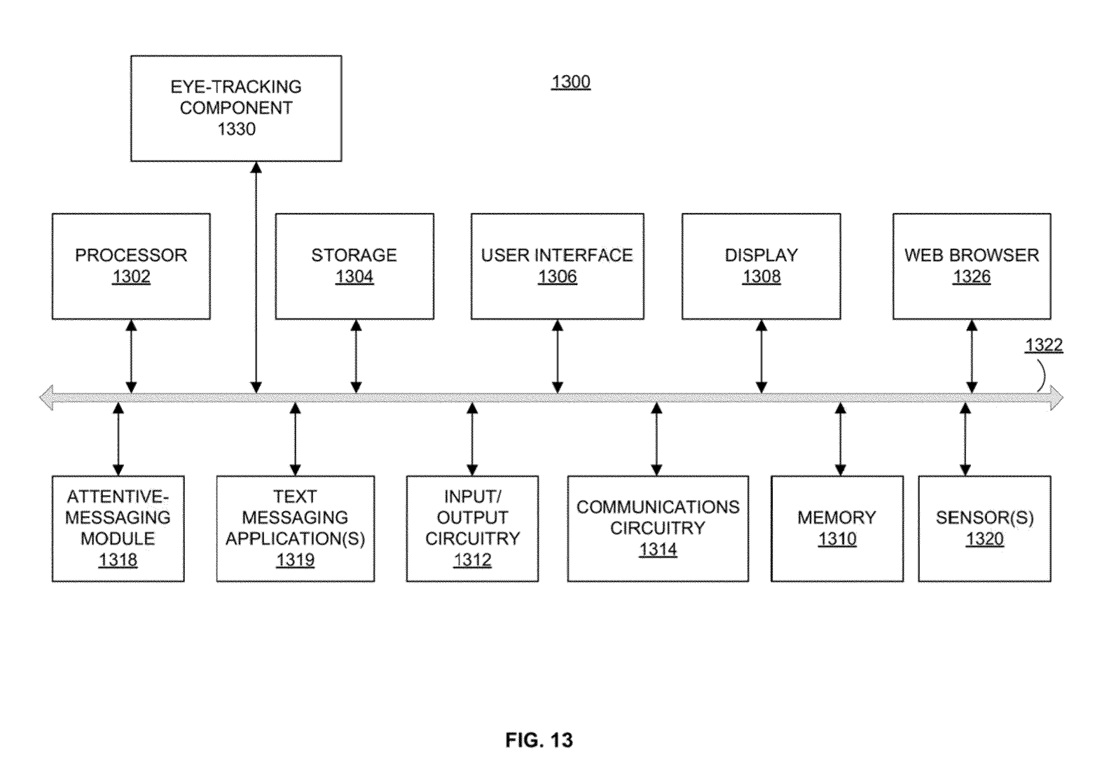

FIG. 12 illustrates an example distributed network architecture that may be used to implement some embodiments. Attentive-messaging module 1210 may be based on a plug-in architecture to mobile device 1230. Attentive-messaging module 1210 may add attentive messaging capabilities to messages accessed with the web browser 1220. Both attentive messaging module 1210 and web browser 1220 may be located on a mobile device 1230, such a cellular telephone, personal digital assistant, laptop computer, or the like. However, the invention is not limited to this embodiment. For example, attentive message module 1210 and web browser 1220 may also be located on a digital device, such as a tablet computer, desktop computer, computing terminal, or the like. Attentive message module 1210 and web browser 1220 may be located on any computing system with a display and networking capability (IP, cellular, LAN, or the like).

Eye-tracking data may be obtained with an eye-tracking system and communicated over a network to the eye-tracking server 1250. Device 1230 GUI data may also be communicated to eye-tracking server 1250. Eye-tracking server 1250 may process the data and map the eye-tracking coordinates to elements of the display. Eye-tracking server 1250 may communicate the mapping data to the attentive messaging server 1270. Attentive messaging server 1270 may determine the appropriate context data to obtain and the appropriate device to query for the context data. Context data may describe an environmental attribute of a user, the device that originated the digital document 1240, or the like. It should be noted that in other embodiments, the functions of the eye-tracking, server 1250 may be performed by a module integrated into the device 1230 that may also include digital cameras, other hardware for eye-tracking, or the like.

In one embodiment the source of the context data may be a remote sensor 1260 on the device that originated the text message 1240. For example, in one embodiment, the remote sensor 1260 may be a GPS located on the device 1240. This GPS may send context data related to the position of device 1240. In addition, attentive-messaging server 1250 may also obtain data from third-party server 1280 that provides additional information about the context data. For example, in this embodiment, the third-party server may be a webpage such as a dictionary website, a mapping website, or the like. The webpage may send context data related to the definition of a word in the digital document. One of skill in the art will recognize that the invention is not limited to these examples and that other types of context data, such as temperature, relative location, encyclopedic data, or the like may be obtained.

FIG. 13 illustrates a simplified block diagram of a device 1300 constructed and used in accordance with one or more embodiments. In some embodiments, device 1300 may be a computing device dedicated to processing multi-media data files and presenting that processed data to the user. For example, device 1300 may be a dedicated media player (e.g., MP3 player), a game player, a remote controller, a portable communication device, a remote ordering interface, a tablet computer, a mobile device, a laptop, a personal computer, or the like. In some embodiments, device 1300 may be a portable device dedicated to providing multi-media processing and telephone functionality in single integrated unit (e.g., a smartphone).

Device 1300 may be battery-operated and highly portable so as to allow a user to listen to music, play games or videos, record video, take pictures, place and accept telephone calls, communicate with other people or devices, control other devices, any combination thereof, or the like. In addition, device 1300 may be sized such that it fits relatively easily into a pocket or hand of the user. By being handheld, device 1300 may be relatively small and easily handled and utilized by its user. Therefore, it may be taken practically anywhere the user travels.

In one embodiment, device 1300 may include processor 1302, storage 1304, user interface 1306, display 1308 memory 1310, input/output circuitry 1312, communications circuitry 1314, web browser 1316, and/or bus 1322. Although only one of each component is shown in FIG. 13 for the sake of clarity and illustration, device 1300 is not limited to this embodiment. Device 1300 may include one or more of each component or circuitry. In addition, it will be appreciated by one of skill in the art that the functionality of certain components and circuitry may be combined or omitted and that additional components and circuitry, which are not shown in device 1300, may be included in device 1300.

Processor 1302 may include, for example, circuitry for, and be configured to perform, any function. Processor 1302 may be used to run operating system applications, media playback applications, media editing applications, or the like. Processor 1302 may drive display 1308 and may receive user inputs from user interface 1306.

Storage 1304 may be, for example, one or more storage mediums, including, but not limited to, a hard-drive, flash memory, permanent memory such as ROM, semi-permanent memory such as RAM, any combination thereof, or the like. Storage 1304 may store, for example, media data (e.g., music and video files), application data (e.g., for implementing functions on device 1300), firmware, preference information data (e.g., media playback preferences), lifestyle information data (e.g., food preferences), exercise information data information obtained by exercise monitoring equipment), transaction information data (e.g., information such as credit card information), wireless connection information data (e.g., information that can enable device 1300 to establish a wireless connection), subscription information data (e.g., information that keeps track of podcasts or television shows or other media a user subscribes to), contact information data (e.g., telephone numbers and email addresses), calendar information data, any other suitable data, any combination thereof, or the like. One of ordinary skill in the art will recognize that the invention is not limited by the examples provided. For example, lifestyle information data may also include activity preferences, daily schedule preferences, budget, or the like. Each of the categories above may likewise represent many various kinds of information.

User interface 1306 may allow a user to interact with device 1300. For example, user interface 1306 may take a variety of forms, such as a button, keypad, dial, a click wheel, a touch screen, any combination thereof, or the like.

Display 1308 may accept and/or generate signals for presenting media information (textual and/or graphic) on a display screen, such as those discussed above. For example, display 1308 may include a coder/decoder (CODEC) to convert digital media data into analog signals. Display 1308 also may include display driver circuitry and/or circuitry for driving display driver(s). In one embodiment, the display signals may be generated by processor 1302 or display 1308. The display signals may provide media information related, to media data received from communications circuitry 1314 and/or any other component of device 1300. In some embodiments, display 1308, as with any other component discussed herein, may be integrated with and/or externally coupled to device 1300.

Memory 1310 may include one or more types of memory that may be used for performing device functions. For example, memory 1310 may include a cache, flash, ROM, RAM, one or more other types of memory used for temporarily storing data, or the like. In one embodiment, memory 1310 may be specifically dedicated to storing firmware. For example, memory 1310 may be provided for storing firmware for device applications (e.g., operating system, user interface functions, and processor functions).

Input/output circuitry 1312 may convert (and encode/decode, if necessary) data, analog signals and other signals (e.g., physical contact inputs, physical movements, analog audio signals, or the like) into digital data, and vice-versa The digital data may be provided to and received from processor 1302, storage 1304, memory 1310, or any other component of device 1300. Although input/output circuitry 1312 is illustrated as a single component of device 51300, a plurality of input/output circuitry may be included in device 1300. Input/output circuitry 1312 may be used to interface with any input or output component. For example, device 1300 may include specialized input circuitry associated with input devices such as, for example, one or more microphones, cameras, proximity sensors, accelerometers, ambient light detectors, magnetic card readers, or the like. Device 1300 may also include specialized output circuitry associated with output devices such as, for example, one or more speakers, or the like.

Communications circuitry 1314 may permit device 1300 to communicate with one or more servers or other devices using any suitable communications protocol. For example, communications circuitry 1314 may support Wi-fi (e.g., an 802.11 protocol), Ethernet, Bluetooth™ (which is a trademark owned by Bluetooth Sig, Inc.) high frequency systems (e.g., 900 MHz, 2.4 GHz, and 5.6 GHz communication systems), infrared, TCP/IP (e.g., any of the protocols used in each of the TCP/IP layers), HTTP BitTorrent, FTP, RTP, RTSP, SSH, any combination thereof, or the like. Additionally, the device 1300 may include a client program, such as web browser 1316, for retrieving, presenting, and traversing information resources on the World Wide Web.

Text message application(s) 1319 may provide applications for the composing, sending and receiving of text messages. Text message application(s) 1319 may include utilities for creating and receiving text messages with protocols such as SMS, EMS, MMS, or the like.

The device 1300 may further include at least one sensor 1320. In one embodiment, the sensor 1320 may be a device that measures, detects or senses an attribute of the device's environment and then converts the attribute into a machine-readable form that may be utilized by an application. In some embodiments, a sensor 1320 may be a device that measures an attribute of a physical quantity and converts the attribute into a user-readable or computer-processable signal. In certain embodiments, a sensor 1320 may also measure an attribute of a data environment, a computer environment or a user environment in addition to a physical environment. For example, in another embodiment, a sensor 1320 may also be a virtual device that measures an attribute of a virtual environment such as a gaming environment. Example sensors include, global positioning system receivers, accelerometers, inclinometers, position sensors, barometers, WiFi sensors, RFID sensors, near-field communication (NFC) devices, gyroscopes, pressure sensors, pressure gauges, time pressure gauges, torque sensors, ohmmeters, thermometers, infrared sensors, microphones, image sensors (e.g., digital cameras), biosensors (e.g., photometric biosensors, electrochemical biosensors), eye-tracking components 1330 (may include digital camera(s), directable infrared lasers, accelerometers), capacitance sensors, radio antennas, galvanic, skin sensors, capacitance probes, or the like. It should be noted that sensor devices other than those listed may also be utilized to ‘sense’ context data and/or user bioresponse data.

In one embodiment, eye-tracking component 1330 may provide eye-tracking data to attentive messaging module 1318. Attentive messaging module 1318 may use the information provided by a bioresponse tracking system to analyze a user's bioresponse to data provided by text messaging application 1319, web browser 1316 or other similar types of applications (e.g., instant messaging, email, or the like) of device 1300. For example, in one embodiment, attentive messaging module 1318 may use information provided by an eye-tracking system, such as eye-tracking component 1330, to analyze a user's eye movements to the data provided. However, the invention is not limited to this embodiment and other systems, such as other bioresponse sensors, may be used to analyze a user's bioresponse.

Additionally, in some embodiments, attentive messaging module 1318 may also analyze visual data provided by web browser 1316 or other instant messaging and email applications. For example, eye tracking data may indicate that a user has a comprehension difficulty with a particular visual component (e.g., by analysis of a fixation period, gaze regression to the visual component, or the like). In other examples, eye tracking data may indicate a user's familiarity with a visual component. For example, in one embodiment, eye-tracking data may show that the user exhibited a fixation period on a text message component that is within a specified time threshold. Attentive messaging, module 1318 may then provide the bioresponse data (as well as relevant text, image data, user identification data, or the like) to a server such as graph servers 1052 and/or bioresponse data server 1072. In some embodiments, entities, such as graph servers 1052 and/or bioresponse data server 1072 of FIG. 10, may provide attentive messaging module 1318 with a list of terms and/or images for which to measure and return bioresponse data. In other example embodiments, attentive messaging module 1318 may collect and transmit bioresponse data for all digital documents (e,g., an MMS, a website, or the like) to a third-party entity. For example, this data may be stored in a datastore (such as datastore 1074 of FIG. 10) and retrieved with a request to bioresponse data server 1072. In some embodiments, attentive messaging module 1318 may generate a table with data of a heat map of a user's viewing, session of a particular text message, web page, or the like.

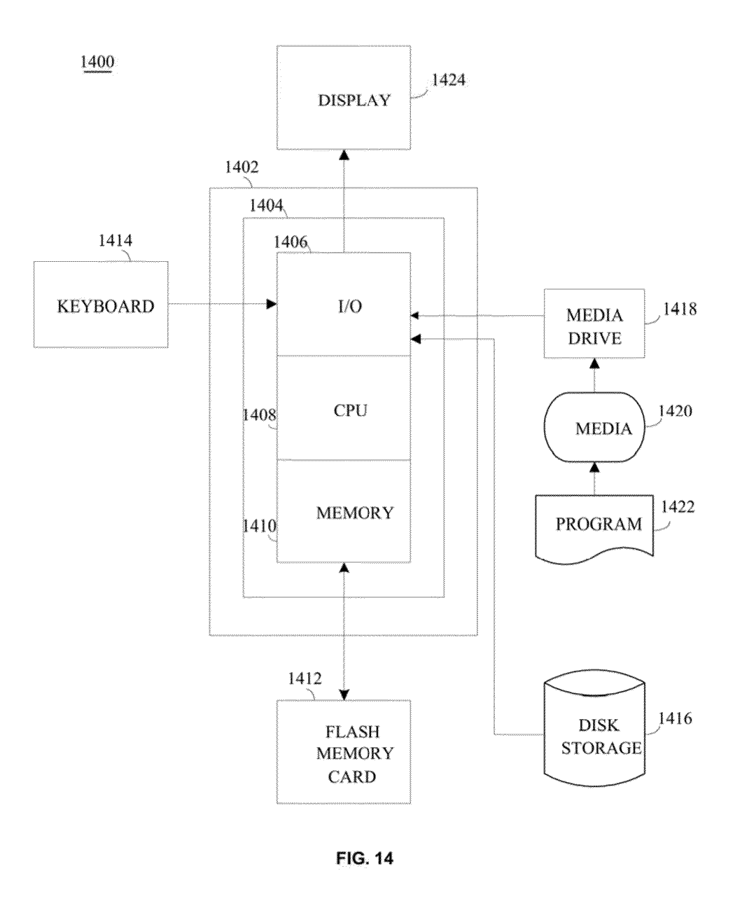

FIG. 14 depicts an exemplary computing system 1400 configured to perform any one of the above-described processes. In this context, computing system 1400 may include, for example, a processor, memory, storage, and I/O devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 14 depicts computing system 1400 with a number of components that may be used to perform the above-described processes. The main system 1402 includes a motherboard 1404 having an I/O section 1406, one or more central processing units (CPU) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

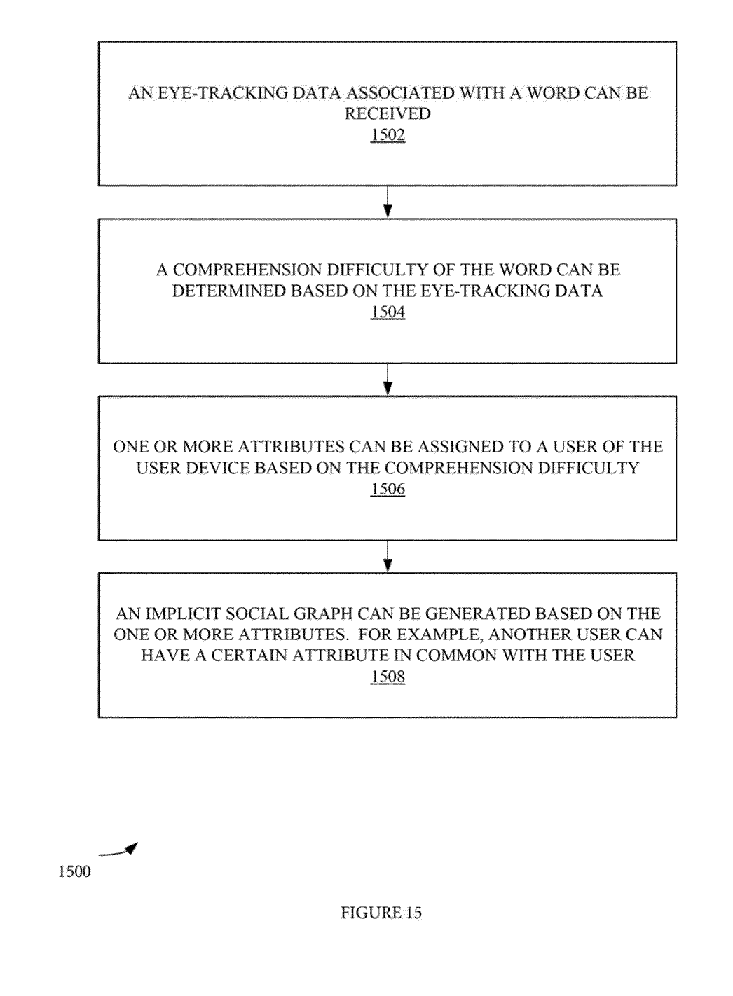

FIG. 15 depicts an example process 1500 of generating an implicit social graph, according to some embodiments. The implicit social graph can be derived from user attributes obtained, in part from user reading comprehension difficulties with respect to text (e.g. a word, phrase, symbol, etc.). In step 1502, an eve-tracking data associated with a word (and/or phrase, symbol, etc.) can be received. The eye-tracking data can be received from a user device (e.g. a smart television with an eye-tracking system, a tablet computer with an eye-tracking system, a head-mounted display with an eye-tracking system, and the like). The word can be a portion of a digital document. The eye-tracking data can include at least one fixation period of substantially seven-hundred and fifty milliseconds (e.g. an initial fixation period) and at least one regression from another portion of the digital document back to the word. In step 1504, a comprehension difficulty of the word (and/or phrase, symbol, etc.) can be determined based on the eye-tracking data The definition of the word, phrase, and/or symbol can be looked up in a digital dictionary and/or other source such as Wikipedia and the like. In step 1506, one or more attributes can be assigned to a user of the user device based on the comprehension difficulty. The one or more attributes are determined based on a meaning of the word, for example. In step 1508, an implicit social graph can be generated based on the one or more attributes. For example, another user can have a certain attribute in common with the user. The two users can then be linked. The link can have a magnitude (e.g. based on recency of the measurement of the attribute, a number of similar measured common attributes, etc.).

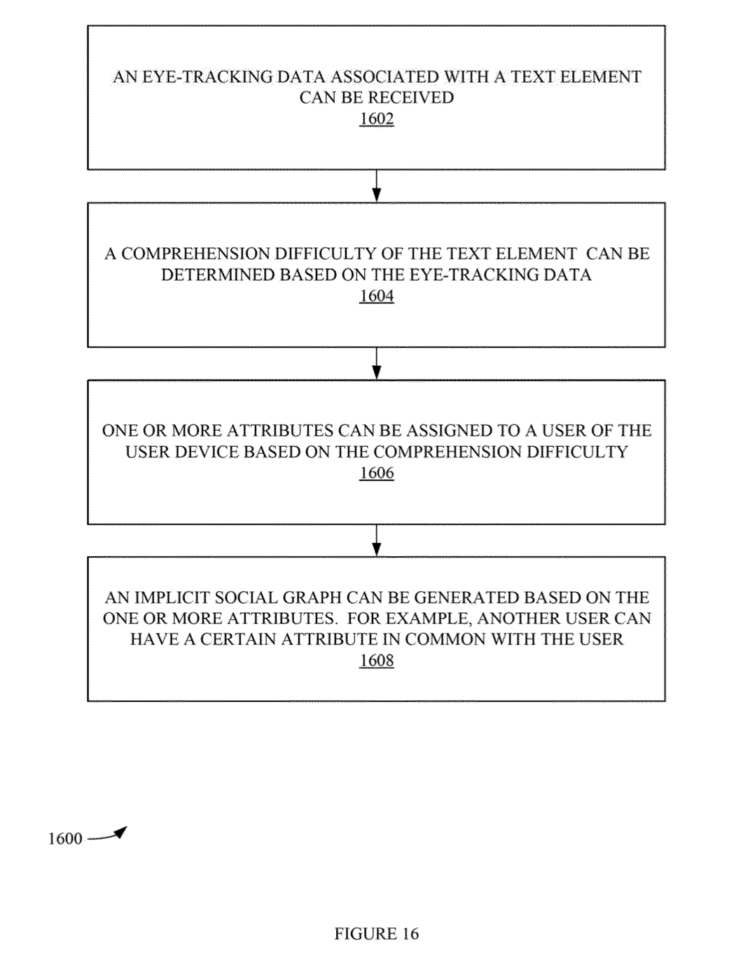

FIG. 16 depicts an example process 1600 of generating an implicit social graph, according to some embodiments. The implicit social graph can be derived from user attributes obtained, in part, from user reading comprehension difficulties with respect to a text element (e.g. a word, phrase, symbol, image in the text, etc.). In step 1602, an eye-tracking data associated with a text can be received. The eye-tracking data can be received from a user device (e.g. a smart television with an eye-tracking system, a tablet computer with an eye-tracking system, a head-mounted display with an eye-tracking system, and the like). The text element can be a portion of a digital document. The eye-tracking data can include at least one fixation period. Example periods include, inter alia, between substantially six-hundred milliseconds and substantially eight-hundred milliseconds substantially (e.g. an initial fixation period), substantially five-hundred milliseconds and nine-hundred milliseconds, substantially five-hundred and fifty milliseconds and substantially nine-hundred and fifty milliseconds, substantially four-hundred milliseconds and substantially six-hundred milliseconds, substantially three-hundred milliseconds and substantially one-thousand milliseconds, arid/or any other period initially beginning less than one second and ending later (e.g. after 100 ms later, 200 ms later, 300 ms later, 400 ms later, 500 ms later, 600 ms later, 700 ms later, 800 ms later, 900 ms later, etc.). In one example, the initial beginning of the fixation period can be at a specified time after a mean word-level fixation average (e.g. a mean word-level fixation average can be 250 ms for a certain user and the initial beginning of the fixation period for measuring a reading comprehension difficulty can be 50 ms, 100 ms, 200 ms, etc. later). A fixation period can be a set static period of time in one example. In another example, the fixation period can be reset based on a user's average fixation-period-per-word. For example, if a user's average fixation-period-per-word for a particular document or time period is two-hundred milliseconds, then the reading comprehension fixation period can be set at some fixed period greater than two-hundred milliseconds. For example, it can be set to be substantially twice the user's average fixation-period-per-word. In another example, the initial fixation period can be substantially twice a mean period of a specified number of preceding words (e.g. twenty preceding words, five preceding words, preceding page of text, preceding words read since last ‘look away’ detected, etc.). Optionally, at least one regression from another portion of the digital document back to the text element can be detected as well before determining a comprehension difficulty with respect to the text. In step 1604, a comprehension difficulty of the text element can be determined based on the eye-tracking data. The definition of the text element, can be looked up in a digital dictionary and/or other source such as Wikipedia and the like. In step 1606, one or more attributes can be assigned to a user of the user device based on the comprehension difficulty. The one or more attributes are determined based on a meaning of the text element, for example. In step 1608, an implicit social graph can be generated based on the one or more attributes. For example, another user can have a certain attribute in common with the user. The two users can then be linked. The link can have a magnitude (e.g. based on recency of the measurement of the attribute, a number of similar measured common attributes, etc.).

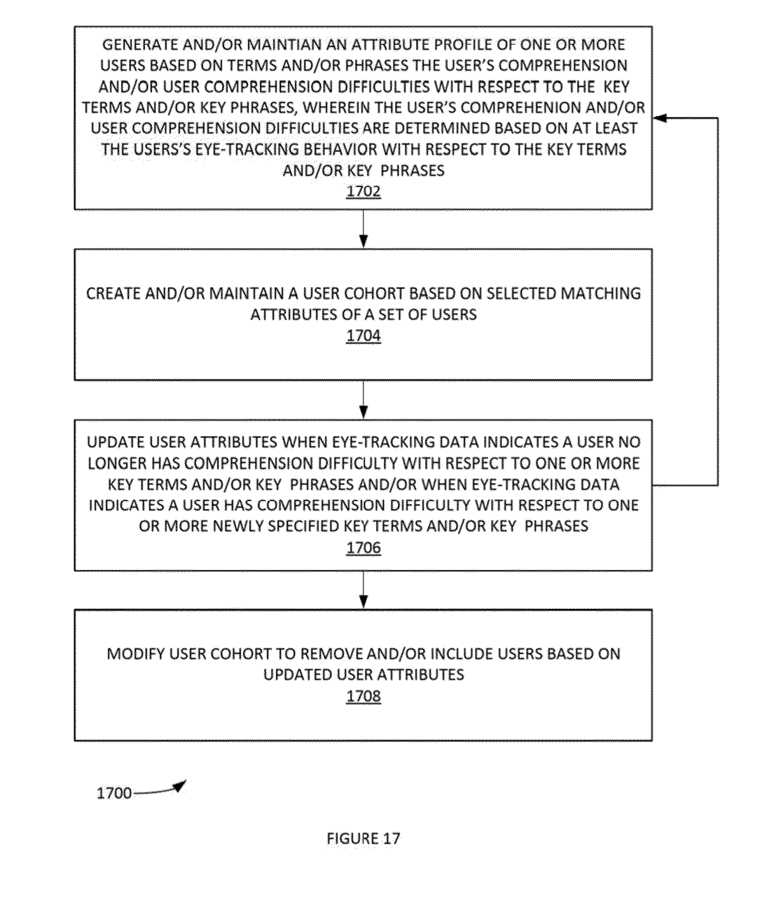

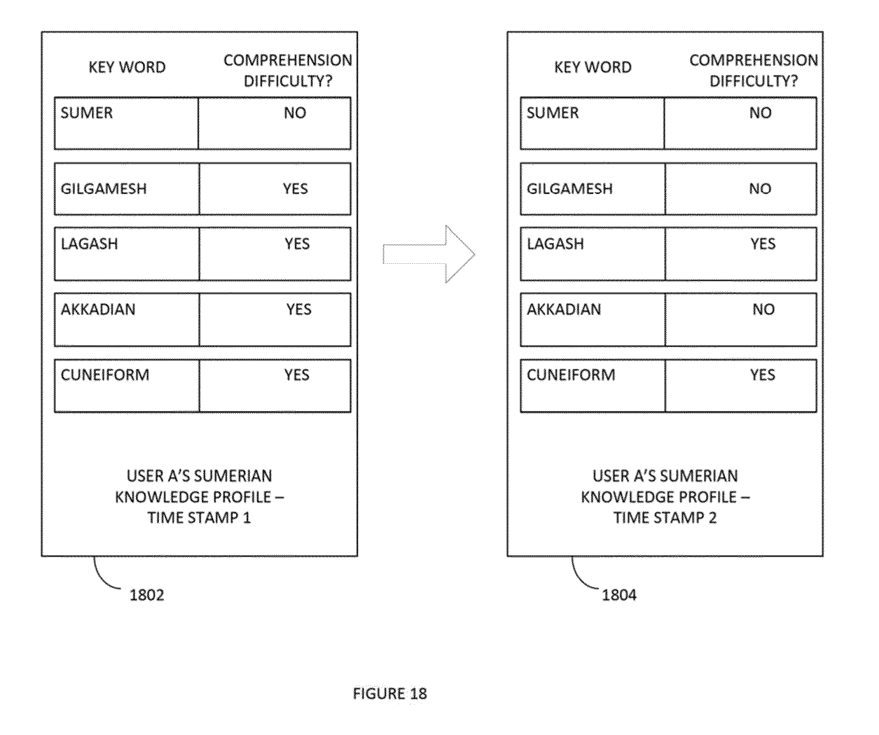

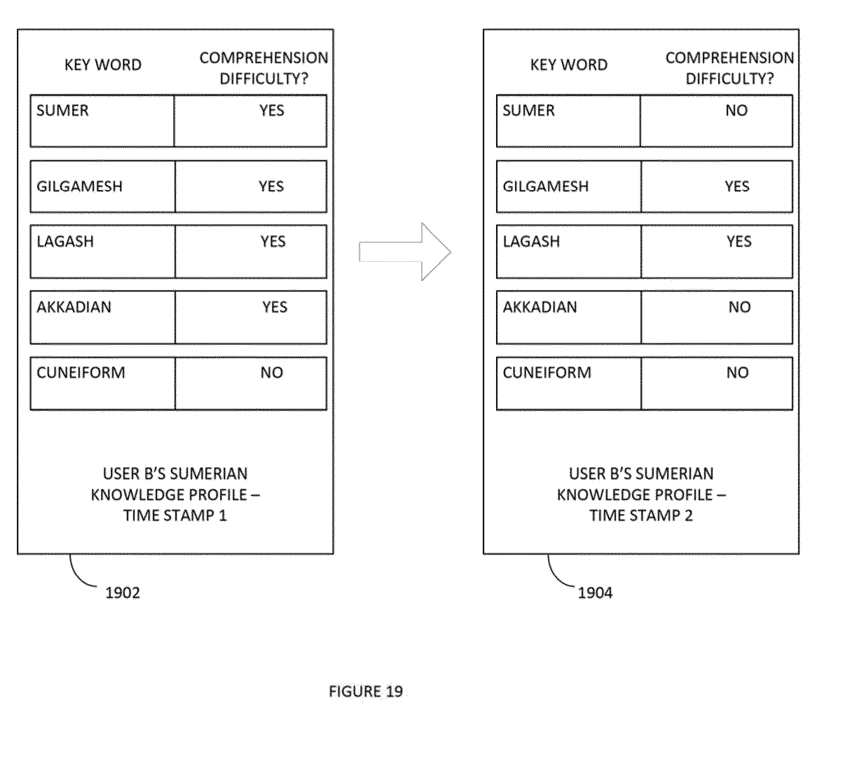

FIG. 17 depicts a process 1700 of generating a user cohort based on common selected user attributes as derived from eye-tracking data, according to some embodiments. A use cohort can include a group of user with common defining characteristics (e.g. user attributes). User attributes can be implied from a user comprehension of key terms and/or phrases as indicated by eye-tracking data (e.g. see supra for various examples and/or parameters of determining user comprehension difficulty with respect words, symbols, phrases, etc.).

In step 1702 of process 1700, an attribute profile (e.g. of a user, of a set of users, etc.) can be generated and/or maintained (e.g. by a server process). The attributes can be based on each user's comprehension difficulties and/or lack of comprehension difficulties vis-à-vis a key term and/or key phrase. An attributes for a set of users can be an aggregated to determine an attribute for the set of users (e.g. can be a sum, weighted mean, an arithmetic mean). Each user's comprehension difficulties and/or lack of comprehension difficulties vis-à-vis a key term and/or key phrase can be based on the respective user's eye-tracking data vis-à-vis the key term and/or key phrase. The attribute can be related to a meaning of the key term and/or key phrase. Attributes can be aggregated to generate another attribute. Attributes can be weighted (e.g. a particular comprehension difficulty for a particular key word can be weighted greater than a comprehension of another key word and the score of each attribute can be used generate another user attribute).

In step 1704, a user cohort can be created and/or maintained based on selected matching attributes of a set of users. The membership of a user cohort can be automatically and/or dynamically updated based on each user's attributes as determined from the respective users eye-tracking data For example, a user may not exhibit a comprehension difficulty with respect to the name ‘Rahul Gandhi’ (e.g. substantially smooth eye movement across each word with a fixation of substantially two-hundred (200) milliseconds for each term; the user's fixation for ‘Rahul’ and ‘Gandhi’ are within a threshold of the average of other recent fixations for similar words that signify the same class of word (e.g. proper names of similar length); etc.). The user may be assigned the attribute ‘FAMILIAR_WITH_INDIAN_POLITICS’. This one attribute can then cause the user to be assigned membership in the user cohort ‘FAMILIAR_WITH_CONTEMPORARY_INDIAN_POLITICS’. Later, eye-tracking, data can indicate a comprehension difficulty with respect to the name ‘Manmohan Singh’. (e.g. the user's fixation for ‘Manmohan’ and ‘Singh’ are not within a threshold of the average of other recent fixations for similar words that signify the same class of word (e.g. proper names of similar length)). Consequently, the user may be dropped from the ‘FAMILIAR_WITH_CONTEMPORARY_INDIAN_POLITICS’ user cohort. Indeed, in one example, comprehension difficulties with respect to such proper names as ‘Manmohan Singh’ and/or ‘Rahul Gandhi’ can cause the user to be placed in a user cohort of ‘NOT_FAMILIAR_WITH_CONTEMPORARY_INDIAN_POLITICS’ (as well as be assigned attributes such as ‘NOT_FAMILIAR_WITH_INDIAN_POLITICS’, ‘NOT_FAMILIAR_WITH_WORLD_LEADERS’, etc). It is noted that the user attribute ‘FAMILIAR_WITH_INDIAN_POLITICS’ can be scored/weighted. In the present example, the user's score/weight for this attribute can be decreased by a specified amount and/or set to zero. Accordingly, in step 1706, user attributes can be updated (e.g. automatically and/or dynamically) when eye-tracking data indicates a user no longer has a comprehension difficulty with respect to one or more key terms and/or key phrases and/or when eye-tracking data indicates the user has a comprehension difficulty with respect to one or more newly specified key terms and/or key phrases. For example, at some specified point, a new Indian politician, ‘Brad Rao’ can be elected to nation office. A user can read the name ‘Brad Rao’ on a news website and eye-tracking data can indicate a comprehension difficulty within a specified parameter (e.g. one or more regressions to each word and/or a fixation of seven-hundred milliseconds for each word). The phrase ‘Brad Rao’ can be set as a key phrase. When the user reads a digital document a thread can automatically search the digital document for the key phrase. User eye-tracking data for the key phrase can be obtained. The user can be in the user cohort ‘FAMILIAR_WITH_CONTEMPORARY_INDIAN_POLITICS’. The comprehension difficulty vis-à-vis the new politician's name can cause the user to be dropped from the user cohort. Thus, in step 1708, the user cohort can be modified to remove and/or include users based on updated user attributes.

In one example of process 1700, a user cohort for ‘KNOWLEDGE_OF_SWEDEN’ can be generated, Key words and/or phrases that relevant to the cohort can be established. This can be done by an administrator and/or automatically by searching a database of key words and/or phrases and generating a list of with definitions that are relevant to ‘KNOWLEDGE_OF_SWEDEN’ within a specified threshold. Digital news (e.g. obtain current Swedish political figures, actors, etc.), maps (obtain geographic names of places in Sweden), travel guides, animal and plant text books (e.g. obtain plants and animal names native and/or unique to Sweden), and the like can also be searched with a search engine to obtain additional, key words and/or terms relevant to ‘KNOWLEDGE_OF_SWEDEN’. Additionally, a list of Swedish vocabulary and/or phrases and be maintained and a user's reading content can be searched to determine if it includes a Swedish word and/or phrase. Swedish words and/or phrases can be automatically included in the list of key words and/or phrases. A user's eye-tracking, for the list of key words and/or phrases can be obtained. In this example, users that did not show a comprehension difficulty vis-à-vis a specified percentage of ‘KNOWLEDGE_OF_SWEDEN’ key words and/or phrases can be included in the ‘KNOWLEDGE_OF_SWEDEN’. These users can be provided a ‘KNOWLEDGE_OF_SWEDEN’ attribute as well. It is noted that a user's ‘KNOWLEDGE_OF_SWEDEN’ attribute can be scored and/or weighted, in this way, some users with less comprehension difficulties vis-à-vis a greater number of key terms and/or phrases that indicate ‘KNOWLEDGE_OF_SWEDEN’ can be scored higher than user's with barely a sufficient number of lack of comprehension difficulties vis-à-vis terms and/or phrases that indicate a ‘KNOWLEDGE_OF_SWEDEN’ cohort membership. 1001111 it is noted that a list of various attributes of users migrating into and/out of the ‘KNOWLEDGE_OF_SWEDEN’ cohort can be generated and maintained. Migrating users can be members of various other cohorts. Probability values that a particular user may migrate to a particular cohort from can be calculated based on the gathered information (e,g, the list) and/or other user attributes. These probabilistic values can be assigned to users of the origin cohort. For example, it can be determined that, based on historical migration data in a particular user set, 75% of users in the ‘KNOWLEDGE_OF_MALTA’ cohort who are not in the ‘KNOWLEDGE_OF_SWEDEN’ cohort eventually migrate to the ‘KNOWLEDGE_OF_SWEDEN’ cohort within a three month period of time. The users in the ‘KNOWLEDGE_OF_MALTA’ cohort can then be assigned a 0.75 probability migration to ‘KNOWLEDGE_OF_SWEDEN’ cohort value. For example, historical analysis can indicate that a user with no comprehension difficulties (e.g. at a set eye-tracking metric such as a fixation of equal to or greater than seven-hundred milliseconds and one regression for a term to indicate a comprehension difficulty) for ‘Stockholm’ and ‘Carl Christoffer Gjörwell’ will have a 0.8 probability of also not exhibiting a comprehension difficulty for ‘Sveriges Kungahus’. Not exhibiting a comprehension difficulty for ‘Sveriges Kungahus’ can be a threshold for entry into the user cohort of ‘HIGH_KNOWLEDGE_OF_SWEDEN’. User cohorts can also indicate progression of knowledge in a subject. For example, a user can exhibit a lack of comprehension difficulty with respect to ‘Stockholm’ but a comprehension difficulty with respect to ‘Carl Christoffer Gjörwell’ and/or ‘Sveriges Kungahus’. Later, the user can exhibit a lack of comprehension difficulty with respect to Stockholm’ and ‘Carl Christoffer Gjörwell’ but a comprehension difficulty with respect to and/or ‘Sveriges Kungahus’. A time stamp for each event can be obtained and stored in a database. The user can be placed in a user cohort ‘LEARNING_ABOUT_SWEDEN’. The user's rate of learning can also be assigned a value. For example, by time difference can indicate the rate the user no longer exhibiting comprehension difficulties for key terms and/or key phrases for a particular topic. In a similar manner a user's decay of knowledge about a particular topic can also be measured and assigned to a user cohort based on an (proportional) increasing percentage of key terms and/or phrases for a topic that the user exhibits comprehension difficulties. Comprehension and comprehension difficulties for key words and/or key phrases can be based on different parameters (e.g. such as those variously provided for in FIGS. 15 and 16 and their concomitant descriptions). Various comprehension and/or lack of comprehension events can be recalculated to normalize their status when using data from different systems that may use different parameters (e.g. can be redetermined when original eye-tracking data available, reassigned (e.g. switched from ‘comprehended’ to ‘did not comprehend’ based on historical probability models, etc.).

In some examples, users can be assigned a particular node in an implicit social network based on a probability of migration to a specified cohort value (e.g. greater then a set threshold.). In some examples, probability of migration to a specified cohort value can decay as a function of time (e.g. longer a user does migrate to another cohort the lower the probability value becomes). Rates of decay can be set according to past historical patterns and/or a user's score for the particular cohort (e.g. score did not reach threshold for inclusion but was increasing at a certain rate, score and/or slope of score as a function of time can be correlated to a probability dependent probability variable in a linear regression analysis, node membership in an implicit social network, etc.). In some examples, a user cohort can correspond with a node in an implicit social graph.

FIG. 18 illustrates an example change in a user profile, according to some embodiments. In the example of FIG. 18, user A's Sumerian knowledge profile at time stamp 1 1802 can be obtained. The Sumerian knowledge profile can include a set of keywords related to Sumerian history and user A's associated comprehension difficulty indicator. For example, user A can read an article on Sumerian history on an e-book reader. The reading session for this article can be indicated as time stamp 1. The article can be scanned by an application in the e-book read to identify which keywords of the set of keywords are extant in the article. The e-book reader can include an eye-tracking system and user A's eye tracking data can be obtained while user A reads the article. A comprehension difficulty parameter(s) can be set to determine whether the user has a comprehension difficulty vis-à-vis a key word (e.g. such as those provided herein). Later user A can read another article about Sumerian history. User A's Sumerian knowledge profile at time stamp 2 1804 can be obtained in a similar manner. User A's Sumerian knowledge profile at time stamp 1 1802 and user A's Sumerian knowledge profile at time stamp 2 1804 can be quantified in various way. For example, the percentage (as well mean and/or other statistical indicators) of keywords comprehended by user A can be calculated at time stamp 1. The percentage (as well mean and/or other statistical indicators) of keywords comprehended by user A can be calculated at time stamp 2. The change in the values of any calculated statistical indicators between time stamp 1 and time stamp 2 can be calculated as well. These calculated values can be included in user A's profile.

FIG. 19 illustrates an example change in a user profile, according to some embodiments. In the example of FIG. 19, user B's Sumerian knowledge profile at time stamp 1 1902 can be obtained. The Sumerian knowledge profile can include a set of keywords related to Sumerian history and user B's associated comprehension difficulty indicator. For example, user B can read an article on Sumerian history on an e-book reader. The reading session for this article can be indicated as time stamp 1. The article can be scanned by an application in the e-book read to identify which keywords of the set of keywords are extant in the article. The e-book reader can include an eye-tracking system and user B's eye tracking data can be obtained while user B reads the article. A comprehension difficulty parameter(s) can be set to determine whether the user has a comprehension difficulty vis-à-vis a key word (e.g. such as those provided herein). Later user B can read another article about Sumerian history. User B's Sumerian knowledge profile at time stamp 2 1904 can be obtained in a similar manner. User B's Sumerian knowledge profile at time stamp 1 1902 and user B's Sumerian knowledge profile at time stamp 2 1904 can be quantified in various way. For example, the percentage (as well mean and/or other statistical indicators) of keywords comprehended by user 13 can be calculated at time stamp 1. The percentage (as well mean and/or other statistical indicators) of keywords comprehended by user 13 can be calculated at time stamp 2. The change in the values of any calculated statistical indicators between time stamp 1 and time stamp 2 can be calculated as well. In some embodiments, the values from FIGS. 18 and 19 can be compared (e.g. using various statistical comparison techniques) to determine whether to include User A and User B in one or more common peer sets. One peer set can be maintained for users that indicate a particular change in comprehension and/or comprehension difficulties vis-à-vis specified key words (e.g. words that a lack of comprehension difficulty would indicate knowledge of Sumerian history). For example, user A and user B changed for four comprehension difficulties to two comprehension difficulties. The value of this change can be used to indicate that user A and user B are learning Sumerian history at a similar rate. Thus, user A and user B can be included in a peer group of users learning Sumerian history and/or a peer group of users learning Sumerian history at the rate specified by FIGS. 18 and 19. These examples can be generalized to other topics and/or includes other statistical analysis methods in other example embodiments Information from FIGS. 18 and 19 can be used with collaborative filtering techniques.

In various embodiments, collaborative filtering can include various methods for processing data (e.g. user comprehension difficulty data and/or lack of user-comprehension difficulty data obtained from user eye-tracking data) to develop profiles of users who are related by similar comprehension-difficulty profiles and/or recent changes in comprehension difficulty profiles with respect certain types of key words. Additionally, in some embodiments, various other recommender algorithms can predict the a ‘preference’ a user would give to an item (e.g. as music, books, or movies) or social element (e.g. people or groups) they had not yet considered, using a model built from the characteristics of an item (content-based approaches) and/or the user's profile developed from user attributes derived from user comprehension difficulty data and/or lack of user-comprehension difficulty data and the meaning of associated key words. In some embodiments, a gradient method (e.g. an algorithm to solve problems with the search directions defined by the gradient of the function at the current point) can be utilized with the various processes and system provided herein. Examples of gradient method can include a gradient descent and/or aconjugate gradient.

It is noted that, in some embodiments, trigger parameters used to indicate a comprehension difficulty can be automatically modified for a user. For example, a time used to indicate a comprehension difficulty and/or a number of regressions back to a word can be modified based on how many times a user has view the word during a particular period/event (e.g. a particular reading session on an e-book; a set period (if time such as past hour, last twenty-four (24) hours, etc.; whether the user has already indicated a reading comprehension difficulty with respect to the word, etc.). For example, the trigger parameters for a reading comprehension can be 750 ms and a regression for the user's first viewing of the word and 500 ms and zero regressions for the second and subsequent viewings of the word. In another example, the subsequent trigger parameters can be function of an average per word fixation time (e.g. a percentage of the first trigger parameter but greater than the current per word fixation time; twice the current per word fixation time; etc.). Conversely, in some embodiments, the values of subsequent trigger parameters can be increased (e.g. from 750 ms to 1000 ms; from one regression to two or more regressions; the fixation time to indicate a comprehension difficulty can increase (or decrease to a fixed lowest threshold in some examples) by a set percentage (e.g. five percent (5%) fifteen (15%), etc. each time the user view the word used in the text, etc.). These examples are provided by way of explanation and not by way of limitation. Other trigger parameters (e.g. reading comprehension difficulty trigger parameters) can be utilized in other embodiments.

At least some values based on the results of the above-described processes can be saved for subsequent use. Additionally, a computer-readable medium (e.g. a non-transitory computer readable medium) can be used to store (e.g., tangibly embody) one or more computer programs for performing any one of the above-described processes by means of a computer. The computer program may be written, for example, in a general-purpose programming language (e.g., Pascal, C, C+ , Java) or some specialized application-specific language.

Although the present embodiments have been described with reference to specific example embodiments, various modifications and changes can be made to these embodiments without departing from the broader spirit and scope of the various embodiments. For example, the various devices, modules, etc, described, herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method of generating an implicit social graph, the method comprising:
receiving an eye-tracking data associated with a word, wherein the eye-tracking data is received from a, wherein the word is a portion of a digital document, and wherein the eye-tracking data comprises at least one fixation period of substantially seven-hundred and fifty milliseconds and at least one regression from another portion of the digital document to the word;
determining a comprehension difficulty of the word based on the eye-tracking data;
assigning, by one or more processors, one or more attributes to a user of the user device based on the comprehension difficulty, wherein the one or more attributes are determined based on a meaning of the word; and
generating, by the one or more processors, an implicit social graph based on the one or more attributes.

2. The computer-implemented method of claim 1, the method further comprising providing a suggestion to the user, based on the implicit social graph.

3. The computer-implemented method of claim 2, wherein providing the suggestion to the user further comprises providing at least one of another suggestion of another user, a product, or an offer.

4. The computer-implemented method of claim 1, further comprising providing a targeted advertisement to the user, based on the implicit social graph.

5. The computer-implemented method of claim 1, wherein the implicit social graph is as weighted graph, and wherein a weight of an edge of the weighted graph is determined by the, one or more of the attributes of the user.

6. The computer-implemented method of claim 1, wherein the implicit social graph is further generated based on a sensor associated with the user device.

7. The computer-implemented method of claim 6, wherein the sensor provides data based on at least one of global position, temperature, pressure, or time.

8. The computer-implemented method of claim wherein the implicit social graph is further generated based on an explicit social graph.

9. The computer-implemented method of claim 1, wherein the digital document is parsed to determine a location of the word.

10. The computer-implemented method of claim 9, wherein an association of the eye-tracking data and the word is determined by mapping the location of the word to a location of the eye-tracking data.

11. The computer-implemented method of claim 9, wherein the digital document is a text message, image, webpage, instant message, email, social networking status update, microblog post, augmented-reality image or blog post.

12. A computer-implemented method of generating an implicit social graph, the method comprising:
receiving an eye-tracking data associated with a text element, wherein the eye-tracking data is received from a user device, wherein the text element is a portion of a digital document, and wherein the eye-tracking data comprises an initial fixation duration of between substantially six-hundred milliseconds and substantially eight-hundred milliseconds:
determining a comprehension difficulty of the text element based on the eye-tracking data;
assigning, by one or more processors, one or more attributes to a user of the user device based on the comprehension difficulty, wherein the one or more attributes are determined based on a meaning of the text element; and
generating, by the one or more processors, an implicit social graph based on the one or more attributes.

13. The computer-implemented method of claim 12, wherein the eye-tracking data further comprises a regressive fixation from another portion of the digital document to the text element, and wherein the regressive fixation occurs at least five-hundred milliseconds after a termination of the initial fixation duration.

14. A computer-implemented method of generating an implicit social graph, the method comprising:
receiving an eye-tracking data associated with a text element, wherein the eye-tracking data is received from a user device, wherein the text element is a portion of a digital document, and wherein the eye-tracking data comprises an initial fixation period of between substantially five-hundred milliseconds and substantially nine-hundred milliseconds;
determining a comprehension difficulty of the text element based on the eye-tracking data;
assigning, by one or more processors, one or more attributes to a user of the user device based on the comprehension difficulty, wherein the one or more attributes are determined based on a meaning of the text element; and
generating, by the one or more processors, an implicit social graph based on the one or more attributes.

15. The computer-implemented method of claim 14, wherein the eye-tracking data further comprises a regressive fixation from another portion of the digital document to the text element, and wherein the regressive fixation occurs at least five-hundred milliseconds after a termination of the initial fixation duration.

16. A computer-implemented method of generating, an implicit social graph, the method comprising:
receiving an eye-tracking data associated with a word, wherein the eye-tracking data is received from a user device, wherein the word is a portion of a digital document, and wherein the eye-tracking data comprises an initial fixation period of substantially twice a mean period of a specified number of preceding words;
determining a comprehension difficulty of the word based on the eye-tracking data;
assigning, by one or more processors, one or more attributes to a user of the user device based on the comprehension difficulty, wherein the one or more attributes are determined based on a meaning of the word; and
generating, by the one or more processors, an implicit social graph based on the one or more attributes.

17. The computer-implemented method of claim 16, wherein the eye-tracking data further comprises a regressive fixation from another portion of the digital document to the word.

18. The computer-implemented method of claim 17, wherein the regressive fixation occurs at least five-hundred milliseconds after a termination of the initial fixation duration.

19. The computer-implemented method of claim 17, wherein the regressive fixation occurs after at least one second after a termination of the initial fixation duration.

20. The computer-implemented method of claim 16, wherein the specified number of preceding words comprises three words of at least four characters each.
